(19) United States
(12) Patent Application Publication
(10) Pub. No.: US 2025/0225402 A1
(43) Pub. Date: Jul. 10, 2025

(54) SYSTEMS AND METHODS FOR IMPROVING PERFORMANCE OF A LARGE LANGUAGE MODEL BY CONTROLLING TRAINING CONTENT

(71) Applicant: ProrataAI, Inc., Pasadena, CA (US)

(72) Inventors: William Tod Gross, Pasadena, CA (US); Andrea Pedretti, Thousand Oaks, CA (US)

(21) Appl. No.: 19/009,697

(22) Filed: Jan. 3, 2025

Related U.S. Application Data
(60) Provisional application No. 63/617,898, filed on Jan. 5, 2024.
(60) Provisional application No. 63/653,702, filed on May 30, 2024.
(60) Provisional application No. 63/728,892, filed on Dec. 6, 2024.

(51) Int. Cl. G06N 3/09; G06N 3/0475

(52) U.S. Cl. CPC G06N 3/09; G06N 3/0475

(57) ABSTRACT

Systems and methods for providing enhanced generative models are disclosed. A prompt from a user device provided to a generative model, such as a large language model, is detect. A response to the prompt, output by the generative model is detected. A contribution of a first item of content, used to train the generative model, to the generative model output is estimate. Feedback is generated based at least in part on the estimated contribution of the first item of content, used to train the generative model, to the generative model output. The feedback generated based at least in part on the estimated contribution of the first item of content, used to train the generative model, to the generative model output is transmitted to one or more networked destinations.

### BACKGROUND OF THE INVENTION

### Incorporation by Reference to any Priority Applications

Any and all applications for which a foreign or domestic priority claim is identified in the Application Data Sheet as filed with the present application are hereby incorporated by reference under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND

### Field of the Invention

The present disclosure relates to large language models and enhancing the performance thereof.

### Description of the Related Art

Large language models and other generative models are becoming an increasingly important technology in content and information production. For example, large language models may be configured to perform a variety of language tasks, such as providing answers to questions, summarizing information, generating human-like text, performing text translations, writing scripts and stories, and/or the like. Large language models are increasingly used in a variety of platforms and applications.

A large language model is a type of machine learning model that uses vast amounts of data to learn the statistical patterns of language, such as grammar, syntax, and vocabulary. By way of example, a large learning model may utilize neural networks and may be trained using unsupervised learning techniques.

Disadvantageously, large language models (LLMs) may not always provide the desired output, wasting computer resources and user time. LLMs suffer from such deficits because they are based on statistical patterns in language data, and their output is no better than the data the LLMs were trained on. LLMs may also generate inaccurate, nonsensical or irrelevant responses if the input is erroneous, unclear or ambiguous to the LLM.

Thus, improved methods of training large language models are needed to provide more accurate and relevant responses to user queries.

### BRIEF DESCRIPTION OF THE DRAWINGS

While each of the drawing figures illustrates a particular aspect for purposes of illustrating a clear example, other embodiments may omit, add to, reorder, and/or modify any of the elements shown in the drawing figures. For purposes of illustrating clear examples, one or more figures may be described with reference to one or more other figures, but using the particular arrangement illustrated in the one or more other figures is not required in other embodiments.

FIG. 1 illustrates an example networked environment.

FIG. 2 illustrates and example device architecture.

FIG. 3A illustrates an example neural network architecture.

FIG. 3B illustrates an example transformer architecture.

FIG. 4 illustrates an example process.

FIGS. 5A-7B illustrate example architectures and processes.

FIGS. 8A-8J illustrate an example process.

FIG. 9 illustrates an example process.

FIG. 10 is a flow chart of the process for determining the contribution of a source to a document generated by an LLM.

### DETAILED DESCRIPTION

As similarly discussed elsewhere herein, large language models (LLMs) and other generative models are becoming an increasingly important technology in content and information production. For example, large language models may be configured to perform a variety of language tasks, such as providing answers to questions, summarizing information, generating human-like text, performing text translations, writing scripts and stories, generating still or video images, generating audio, and/or the like. LLMs may thus be utilized in many different types of applications, such as chatbots, language processing, and content creation. Examples of large language models include GPT-4, PaLM, and LaMDA.

An LLM may be utilized to generate audio, such as speech. For example, the text output of an LLM may be provided to a text-to-speech (TTS) engine that converts the LLM generated text (e.g., a script, story, article, etc.) into spoken, audible speech. The TTS engine may be configured to analyze the LLM-generated text to understand its structure, which may include identifying words, sentences, punctuation, and other linguistic features. The TTS engine may perform linguistic processing, such as performing phonetic analysis to determine the pronunciation of words and prosodic analysis to determine the rhythm, stress, and intonation of speech. Waveform synthesis may be performed to generate the actual audio waveform from the processed text. Waveform synthesis may be performed using concatenative synthesis utilizing pre-recorded speech segments that are concatenated to form complete utterances. Waveform synthesis may be performed using parametric synthesis, wherein one or more mathematical models are used to generate speech.

Neural networks may in addition or instead be used to perform waveform synthesis to thereby enhance the naturalness and quality of synthetic speech by generating waveforms directly from linguistic features or spectrograms.

As similarly discussed elsewhere herein, a large language model is a type of machine learning model that uses vast amounts of data to learn the statistical patterns of language, such as grammar, syntax, and vocabulary. By way of example, a large learning model may utilize one or more neural networks and may utilize a transformer architecture. The LLM may be trained using unsupervised learning techniques.

AI image (still image or video image) generators (e.g., generative adversarial networks, variational autoencoders, transformers for image generation, conditional image generation, style transfer models, or the like) sometimes referred to as generative models, may be used to create images (still images or video images) that resemble real-world images or follow a specific style or theme (e.g., specified by a user).

Disadvantageously, large language models and AI image generators may not always provide the desired output, wasting computer resources and user time. LLMs suffer from such deficits because they are based on statistical patterns in language data, and their output is no better than the data the LLMs were trained on. LLMs may also generate inaccurate, nonsensical, or irrelevant responses if the input is erroneous, unclear or ambiguous to the LLM. Additionally, because of concerns that the use of certain content for LLM training may violate rights of the content owners (e.g., copyrights in the content) the amount and/or quality of the content that may be used for training may decrease.

Disclosed herein are techniques for improving the training, and hence the performance and output of large language and other generative models using improved techniques for obtaining training content and determining the contribution of training content to the model and/or model output.

As described herein, various techniques may be used to detect the source and/or authorship of training content (e.g., used to train an LLM) and the contribution of a given item of learning content to the training and output of large language and other generative models. In contrast with conventional techniques for identifying copyright infringement, which look for exact or near exact copies of a copyrighted work, an aspect of the present disclosure relates to determining from an output of an LLM whether the LLM was trained using a given document, even though the output does not contain copies of any text from the given document.

An aspect of the present disclosure relates to using labels assigned to an item of content used for training to predict a contribution of the item of content to the training and output of large language models.

An aspect of the present disclosure relates to determining/estimating an amount or percentage a given item of content contributes to a neuron weight (e.g., a change in a neuron weight) in a large language or other generative model neural network or transformer network comprising a neural network, wherein the transformer network utilizes self-attention mechanisms to process input data in parallel.

An aspect of the present disclosure relates to examining the content output by an LLM using another model (e.g., comprising a neural network, another LLM comprising a transformer network, or other model) to determine the contribution a given item of training content to the training and output of large of a language model.

Optionally, a large language or other generative model may be trained using content that is no longer protected by copyright, was affirmatively placed in the public domain, or was affirmatively submitted for the purposes of model training (e.g., including an express agreement to permit the submitted content to be used for training, even if the content appears in a response to a user query or instruction). Thus, because the large language or other generative model does not use content without permission or that does not have intellectual property protection, there may be a greatly reduced risk that a content owner will claim intellectual property infringement. Further, because the source of training content is optionally restricted to sources that are more likely to be reliable, the output of the trained LLM is more likely to be reliable as well.

Content may be affirmatively submitted by a content owner (or other entity that has the right to license content to be used for training LLMs) by uploading the content or providing a link to content to a website associated with an LLM to be trained. The submitter may need to agree to affirmatively permit the submitted content to be used for training by activating an agreed control presented in association with terms of submission.

The training content may include books, articles, websites, and other textual content that reflects the diversity of language and knowledge. If the LLM is a multimodal model (e.g., configured to generate images based on a user specification as well as text), a diverse and large dataset of images may be collected and used for training. In the case of audio, digitized audio may be utilized to train an audio generator (e.g., a neural network TTS engine).

Optionally, the collected data may undergo preprocessing to clean and format the data to be suitable for training the LLM. For example, irrelevant information may be removed, errors may be corrected, and/or data formatted so that the model can understand the data. The training text may be broken down into smaller units called tokens (e.g., where a token may be a single character or a set of characters such as a word). Such tokenization may enable the LLM to analyze and generate text at a granular level.

The LLM may be trained using the preprocessed dataset. During training, with respect to text outputs, the model learns to predict the next word or token in a sequence given the context of the preceding words. The training process comprises adjusting the model's parameters to minimize the difference between its predictions and the actual data. Optionally, after the initial training, the LLM may be trained on a more specialized dataset related to a targeted task or domain to enhance its performance with respect to such tasks or domains.

Optionally, during training, the LLM's performance may be periodically evaluated on validation datasets to ensure the LLM is learning effectively and not overfitting to the training data. The training process may be modified based on these evaluations.

With respect to training the LLM on images, the images may be labeled. For example, the labeling may be performed by a training content submitter. The labels may be utilized to determine and select which images would provide proper model training for a given task. The labels may describe the image content, the image mood, the image style (e.g., medieval, Renaissance, impressionist, abstract, Pop, Magna, etc.) the image lighting, the image source (e.g., museum name, newspaper name, artist name, private individual name, etc.), and/or other image related data. The images may be preprocessed (e.g., resized, cropped, normalized, and/or other transformation) so that the images are in a format suitable for training the LLM.

An aspect of the present disclosure relates to generating a weighting for a given item of potential training content using such labels. For example, the number of labels that are relevant for a particular LLM task or domain may be used to calculate a weight that may be reflective on the anticipated usefulness of the content in training an LLM. Optionally, each label may be assigned a weight based on its projected usefulness or relevance. For example, with respect to an image, a content label (e.g., indicated one or more items in the image, such as “man,” “car,” etc.) and a source label (which may be indicative of the content reliability) may be weighted more heavily than a label related to image lighting. The label weights may be aggregated and optionally normalized into an overall content weight. The aggregated content weight may be stored in memory in association with an identifier of the corresponding item of content and may be used to provide feedback to a source of the item of content reflective of the contribution the item of content made to the training of the LLM training and/or output.

Optionally, the images are converted into embeddings (e.g., numerical representations) that the LLM can understand. For example, the process of converting an image to embeddings may be performed using convolutional neural networks (CNNs), for image feature extraction, where the CNN may be pre-trained and may comprise an input layer, convolutional hidden layers, pooling layers, and an output layer.

Conventionally, determining the content used to train an LLM can be challenging, as this information is often not disclosed publicly due to privacy, copyright, and proprietary considerations. Further, even where it is possible to determine the content used to train an LLM, conventionally it is not possible to determine the contribution a given item of content made to the training of the LLM.

An aspect of the present disclosure relates to the use of the aggregated, and optionally normalized, aggregated label weights to provide feedback to the content sources reflective of such contribution to the adjustment of parameters. The feedback may comprise the aggregated and/or individual label weights, a percentage contribution to the LLM adjustment of parameters, a score or grade reflective of the contribution to the LLM adjustment of parameters, and/or a token (e.g., a financial payment, an access code to one or more online resources (such as an LLM), or other item of value) reflective of the contribution to the LLM adjustment of parameters. For example, a set amount of tokens may be allocated to a given LLM training process, and the distribution of the set amount of tokens may be divided amongst content providers based at least in part on the respective content weights. Tokens may be transmitted to a user via email, a messaging service, a downloaded application on a user device or otherwise. The token may be transferred to a user account (e.g., a financial account). By way of further example, multiple labels may be generated for multiple items of content and the pro rata contribution may be determined for each individual item (e.g., where an item is a portion of text) based on each item's percentage of the whole collection of items. For example, there may be 23 labels associated with one item, but those 23 labels represent 4.5% of all the labels for that portion of text. A benefit in the way of tokens or otherwise may be provided to the source of the item based on 23 labels, or based on the 4.5% contribution. It is understood that a first set of multiple labels may be associated with a first item or portion of content and a second set of multiple labels may be associated with a second item or portion of content, where the first set and the second set may include completely different labels, the same labels, or certain common labels and certain different labels.

Another aspect of the present disclosure relates to the use of neuron model weights (and/or other parameters) and/or changes thereto to determine the contribution a given item of training content made to an LLM and/or LLM output, to provide feedback to the content sources reflective of such contribution. A contribution score or other indicator may be generated using such determination for respective items of content used for training.

The feedback may comprise the contribution score, grade, or other such contribution indicator, a percentage contribution to the LLM adjustment of parameters, and/or a token (e.g., a financial payment, an access code to one or more online resources (such as an LLM), or other item of value) reflective of the contribution to the LLM training and/or output (e.g., reflective of the contribution score). As discussed elsewhere herein, tokens may be transmitted to a user via email, a messaging service, a downloaded application on a user device or otherwise. The token may be transferred to a user account (e.g., a financial account).

It is understood that although the foregoing discussion assumes that content items from content sources were used to train a generative model, the estimated contribution of one or more content items to a given item of generated content may be independent of the technology or techniques used to generate the generated content. Feedback may be assigned in a pro rata manner based at least in part on the estimated proportional or percentage contribution for various items of content to a item of generated content. Such feedback may be provided as similarly discussed above and elsewhere herein.

For example, the training of an LLM may involve one or more of the following actions. The training of certain other types of generative models may be similarly performed.

The LLM's parameters (e.g., weights and biases) may be initialized (e.g., randomly). Input data (e.g., text) is fed into the LLM, and the LLM makes predictions. For example, in the case of language LLMs, the LLM may predict the next word in a sequence given the previous words.

A loss function may be used to quantify the difference between the LLM's predictions and the actual (target) values. In order to improve the predictive accuracy of the LLM, the goal is to minimize this loss so that the prediction more closely matches the target. The gradients of the loss with respect to the LLM's parameters (e.g., weights and biases) are computed. For example, the chain rule of calculus, which calculates derivatives, may be used to calculate the error gradient of the loss function with respect to respective weights of the network. The LLM's parameters are then updated in the opposite direction of the computed error gradients (e.g., using an optimization algorithm, such as stochastic gradient descent (SGD) or the like). The foregoing process may be repeated on batches of data until the LLM's performance improves, and the loss is minimized to a satisfactory degree (e.g., below a certain threshold).

Certain training content may make a greater contribution to the adjustment of parameters, and hence to the model accuracy than other training content. Such contribution to the adjustment of parameters may be stored in memory and may be used for providing feedback (e.g., textual feedback such as a score or grade, graphic feedback such as an emoji, or a token corresponding to a financial payment, access to an online resource, or other item of value) to the content sources reflective of such contribution to the adjustment of parameters.

During this training process, the weights associated with neurons are adjusted to minimize the difference between the LLM's predictions and the actual outcomes. The learning rate is a hyperparameter that determines the size of the steps taken during the parameter updates.

Thus, neurons (or parameters, including weights) are adjusted based on the gradients of the loss function with respect to those parameters, and this adjustment is performed iteratively through multiple training cycles until the model achieves satisfactory performance.

Optionally, various post-training operations of an LLM (or other generative model) may be used to estimate the contribution of a given item of content to the training of the LLM and/or the LLM output.

For example, another LLM or other generative model may be used to perform prompt engineering, wherein prompts are generated to elicit specific responses from the LLM (or other generative model) that may indicate the source of its training data. The prompt-generation LLM may generate different types of queries and observe how the LLM being analyzed responds. By way of further example, known and unique phrases, sentences, paragraphs, or queries may be input to the LLM being analyzed and LLM output may be analyzed to determine whether the model has been trained using the same or similar content.

By way of further example, stylometric analysis, wherein the writing style of the LLM's output may indicate the source of the training data, may be used. By way of illustration, if the LLM or other generative model consistently produces outputs in a certain writing or image style, it may indicate a predominant influence from a specific source. Stylometric may be performed using Support Vector Machines (SVPs) comprising a supervised learning algorithm configured to perform classification tasks, such as authorship attribution. The SVP may perform such authorship attribution by finding the hyperplane that best separates different classes in the feature space. A Random Forest may perform such authorship attribution using multiple decision trees and by merging their predictions. By way of still further example, a probabilistic algorithm, such as Naive Bayes may be used for authorship attribution by modeling the probability distribution of word occurrences.

By way of additional example, deep learning techniques, such as recurrent neural networks (RNNs) or long short-term memory networks (LSTMs), may be utilized to perform stylometric analysis by learning complex patterns in sequential data to identify writing styles, and hence authorship. One or more statistical and linguistic features, such as word frequencies, sentence lengths, punctuation usage, and/or syntactic structures, may be used as input features to a machine learning algorithm to capture and identify the unique writing style of authors.

By way of further example, a K-Nearest Neighbors (KNN) algorithm may be utilized to classify data points based on the majority class of their k-nearest neighbors in the feature space. Authorship attribution may be performed by measuring the similarity between texts.

Optionally, ensemble methods, combining the predictions of multiple analysis models, may be utilized to improve the robustness and accuracy of stylometric analysis. For example, the outputs of different algorithms or models may be combined/aggregated to provide a source/authorship identification and/or to determine the contribution an item of content made to the training and/or output of the LLM.

By way of yet further example, where the domain in which the LLM has been trained is known, the LLM's performance on specific domain-related tasks may be analyzed to deduce what content in that domain was used to train the LLM.

Once the contribution level of a given content item has been determined using one or more of the foregoing or other techniques, feedback may be transmitted to the content sources reflective of such contribution to the LLM training/output (e.g., the contribution to the adjustment of parameters). The feedback may comprise a percentage contribution to the LLM adjustment of parameters, a score or grade reflective of the contribution to the LLM adjustment of parameters, and/or a token (e.g., a financial payment, an access code to one or more online resources (such as an LLM), or other item of value) reflective of the contribution to the LLM adjustment of parameters. The feedback may be provided in substantially real time and/or at a specified scheduled time (e.g., the first day of the month, Monday each week, or other scheduled time).

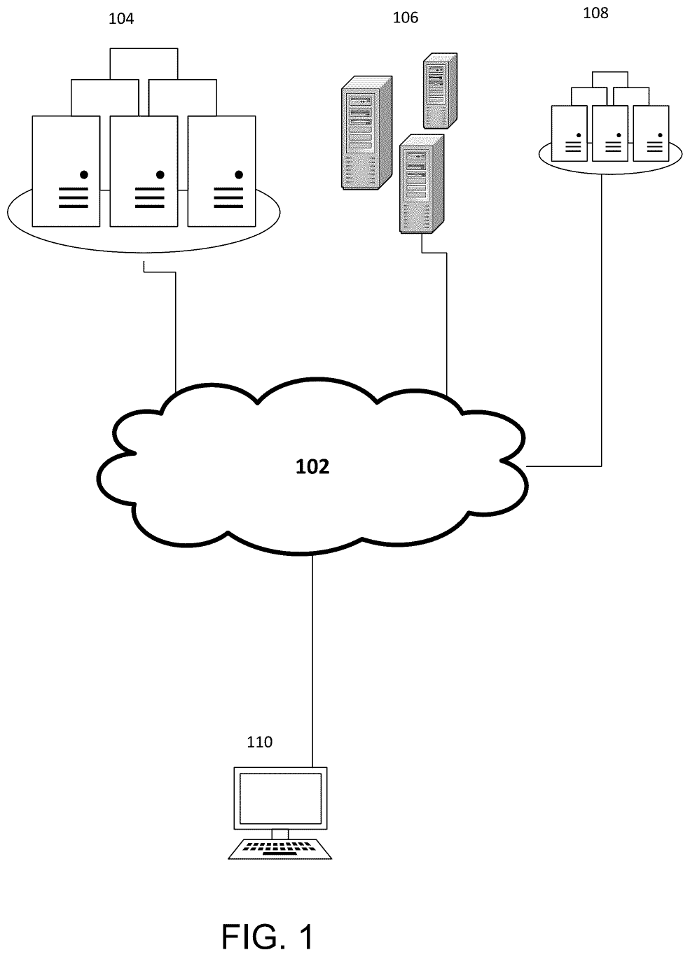

FIG. 1 illustrates an example environment which may be utilized with the processes and systems described herein. Although certain examples may refer to an LLM, the disclosed processes and systems may similarly be utilized with respect to other generative models, such as artificial intelligence (AI) image generators, Autoregressive Models, Bayesian Networks, Generative Adversarial Networks, Gaussian Mixture Models, Hidden Markov Models, Latent Dirichlet Allocation (LDA) models, and/or Variational Autoencoders (VAEs).

An LLM system 104 is configured to generate an LLM. The LLM system 104 may comprise a cloud system. With respect to the cloud-based computer system implementation, the cloud-based computer system may comprise a hosted computing environment that includes a collection of physical computing resources that may be remotely accessible, located at different facilities, and may be rapidly provisioned as needed (sometimes referred to as a “cloud” computing environment). Certain data described herein may optionally be stored using a data store that may comprise a hosted storage environment that includes a collection of physical data storage devices that may be remotely accessible and may be rapidly provisioned as needed (sometimes referred to as “cloud” storage). Optionally, some or all of the LLM system 104 functionality may be incorporated into the user device 110.

The LLM system 104 may ingest vast amounts of text content and optionally image and sound content from a large variety of sources (e.g., webserver 106, database 108, or the like) including webpages, books, magazines, articles, and other publications. Such data may be used to train the LLM system 104 (e.g., using an unsupervised or supervised learning approach). The LLM system 104 may access such content from corresponding systems over a network 102 (e.g., the Internet, an intranet, a wide area network, etc.). Optionally, as described elsewhere herein, the LLM system 104 may restrict the content used to train the LLM to content that is no longer protected by copyright, was affirmatively placed in the public domain, or was affirmatively submitted for the purposes of model training. For example, the LLM system 104 may provide a user or computer interface to one or more content source systems via which content for training may be uploaded or via which a link to content for training may be provided. Such training content may be stored by the system 104 to be used in training. Optionally, the content submitter is provided with an interface via which the content submitter can authorize the use of the content for LLM training and warranting that they have the right to submit the content for LLM training.

Optionally, the LLM system 104 may utilize natural language processing (NLP) to extract keywords, sentiment analysis to determine the mood, and/or semantic parsing to extract the structure of the input text.

As similarly discussed elsewhere herein, the LLM system 104 may optionally be configured with other generative models which may be used to analyze the output of the LLM (or other generative model) to identify the source and/or authorship of the content used to train the LLM and to determine a contribution of the content to the training and/or output of the LLM. In addition, as similarly discussed elsewhere herein, the LLM system 104 may optionally be configured to select training content based at least in part on associated labels and to determine a contribution an item of content to the training and/or output of the LLM (or other generative engine). The LLM system 104 may optionally be configured to provide feedback to sources of training content based on the use and contribution of an item of content to the training and/or output of the LLM.

The feedback may comprise aggregated and/or individual label weights, a percentage contribution to the LLM adjustment of parameters, a score or grade reflective of the contribution to the LLM adjustment of parameters, and/or a token (e.g., a financial payment, an access code to one or more online resources (such as an LLM), or other item of value) reflective of the contribution to the LLM adjustment of parameters. For example, a set number of tokens may be allocated to a given LLM training process, and the distribution of the set amount of tokens may be divided amongst content providers based at least in part on the respective content weights that reflect their respective contributions to the LLM training. Tokens may be transmitted by the system 104 to a user via email, a messaging service, a downloaded application on a user device and/or otherwise. Tokens may be transferred to a user account (e.g., a financial account). By way of further example, as similarly discussed elsewhere herein, one or more labels may be generated for multiple items of content and the pro rata contribution may be determined for each individual item (e.g., where an item is a portion of text) based on each item's percentage of the whole collection of items and/or based on the number of labels associated with a given item.

The LLM system 104 may communicate with one or more end user devices 110 (e.g., a computing device, such as a smartphone, a desktop computer, a laptop computer, a tablet, a smart television, a game console, a smart watch or other wearable, and/or the like) over the network 102. For example, the LLM system 104 may provide one or more user interfaces (e.g., in a webpage or an application) via which a user may enter prompts or queries. The prompts or queries entered (e.g., via a keyboard, voice, or otherwise) by the user into corresponding user interface fields may be transmitted from the user device 110 to the LLM system 104. The LLM system 104 may in turn generate response(s) to the user query/prompt that and transmit the response(s) to the user device 110, which may display and/or read out the response(s) to the user. Optionally, a user may submit content via a user device 110 to the LLM system 104 to be used for LLM (or other generative model) training.

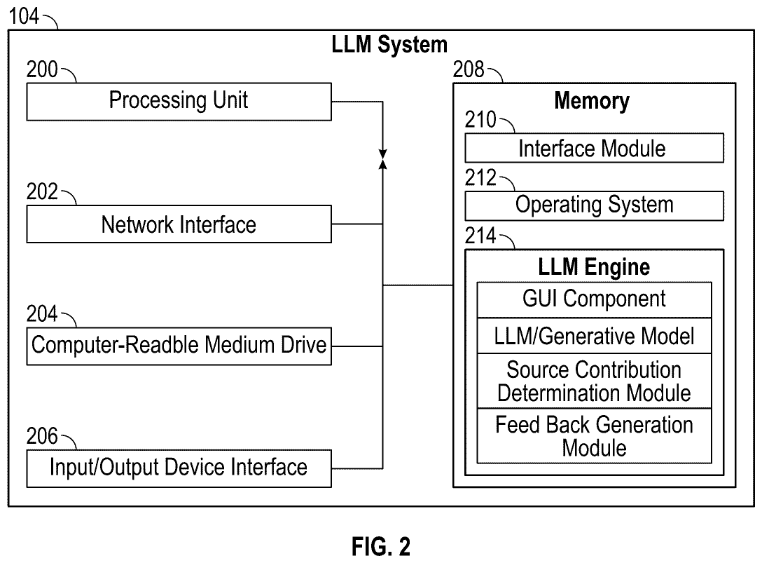

FIG. 2 is a block diagram illustrating example components of the LLM system 104. The example LLM system 104 includes an arrangement of computer hardware and software components that may be used to implement aspects of the present disclosure. Those skilled in the art will appreciate that the example components may include more (or fewer) components than those depicted in FIG. 2. Optionally, computer hardware and/or software components illustrated in FIG. 2 may be instead or also be included in other systems depicted in FIG. 1.

The LLM system 104 may include one or more processing units 200 (e.g., one or more general purpose processors and/or high speed graphics processors comprising one or more processor cores including arithmetic logic units, FFT processors, registers, input/output buses, and/or the like), one or more network interfaces 202, a non-transitory computer-readable medium drive 204, and an input/output device interface 206, all of which may communicate with one another by way of one or more communication buses. The network interface 202 may provide services described herein with connectivity to one or more networks or computing systems (e.g., LLM systems, webservers, user devices, etc.). The processing unit 200 may thus receive models and/or information (e.g., LLM models, webpages, other content used to train the LLM models, authorization to use content for model training, etc.), and/or instructions from other computing devices, systems, or services via a network, and may provide responsive data and/or execute instructions. The processing unit 200 may also communicate data to and from memory 204 and further provide output information via the input/output device interface 206. The input/output device interface 206 may also accept input from one or more input devices, such as a keyboard, mouse, digital pen, touch screen, microphone, camera, etc.

The memory 208 may contain computer program instructions that the processing unit 200 may execute to implement one or more aspects of the present disclosure. The memory 208 may include RAM, ROM (and variants thereof, such as EEPROM) and/or other persistent or non-transitory tangible computer-readable storage media. An interface module 210 may provide access to data in the memory 208 and may enable data to be stored in the memory 208. The memory 208 may store an operating system 212 that provides computer program instructions for use by the processing unit 200 in the general administration and operation of an LLM engine 214, including its components.

The memory 208 may store user data (for end users and/or training content submitters), such as user credentials, user preferences with respect to the generation of LLM responses, a history of queries, query answers, user-submitted content and a user acknowledgment that the content may be used for generative network training, feedback (such as that described herein) provided to users, and/or other content and data described herein.

Some or all of the data and content discussed herein may optionally be stored in a relational database, an SQL database, a NOSQL database, or other database type. Optionally, the memory 208 may include one or more external third party cloud-based storage systems.

The LLM engine 214 may include a GUI component that generates graphical user interfaces and processes user inputs (e.g., LLM queries/prompts, content submissions, agreements that submitted content (e.g., text, image, and/or audio) may be used for training, and/or other user inputs described herein) and an LLM (e.g., a generative model comprising a neural network, such as an encoder-decoder recurrent neural network, optionally comprising a transfer architecture) configured to generate and/or select content to present to the user. The LLM may be trained using some or all of the data described herein and/or other data.

Optionally, the LLM engine 214 may comprise a transformer architecture that utilizes self-attention, which enables the model to selectively focus on different parts of the input sequence during the encoding process. The transformer architecture may comprise an encoder and a decoder, connected through a one or more multi-head attention and feedforward layers.

The encoder is configured to receive an input sequence and process it using multi-head self-attention, where the input sequence is transformed into a set of query, key, and value vectors. The query, key, and value vectors may be used to compute the attention scores between given positions in the sequence, enabling the model to identify the relevant (e.g., most relevant) portions of the input sequence for respective positions.

The decoder is configured to receive the encoder output and generate an output sequence. The decoder may also utilize multi-head attention and may be further configured with an additional attention mechanism that enables the decoder to attend to the encoder output and to generate the output sequence using the relevant information from the input sequence. For example, an attention module may repeat its computations several times in parallel, which may be referred to as respective attention heads. Optionally, the attention module splits Query, Key, and Value parameters N-ways and passes each, independently, through a separate attention head.

The transformer architecture may comprise one or more feedforward layers, which apply a linear transformation followed by a non-linear activation function to the output of the attention layers. The feedforward layers facilitate further capture patterns in the input and output sequences.

The transformer may comprise a loss function that measures the difference between the predicted output sequence and the true output sequence. The transformer is configured to minimize or reduce the loss function output. Backpropagation may be utilized as part of the minimization process, where the gradients of the loss function with respect to the model parameters are calculated and used to update the model weights (e.g., associated with neural network layers).

The LLM engine 214 may include a module configured to determine or estimate the contribution of a given item of content or items of content to the training of the LLM (or other generative model) and/or the output of the LLM (or other generative model). For example, as similarly discussed elsewhere herein, labels assigned to an item of content may be used to select the item of content for LLM (or other generative model) training and/or may be used to predict/estimate a contribution of the item of content to the training and output of the LLM (or other generative model). By way of further example, as similarly discussed elsewhere herein, an amount or percentage a given item of content contributes to a neuron parameter (e.g., a change in a neuron weight) in a large language or other generative model may be determined. By way of still further example, as similarly discussed elsewhere herein, the content output by the LLM (or other generative model) may be analyzed using another model (e.g., comprising a neural network, another LLM comprising a transformer network, or other model) to determine the contribution a given item of training content to the training and output of large of a language model. As similarly discussed elsewhere herein, one or more labels may be generated for one or more items of content and the pro rata contribution may be determined for each individual item (e.g., where an item is a portion of text, a portion of a video, a portion of an image, and/or the like) based on each item's percentage of the whole collection of items and/or based on the number of labels associated with a given item. As similarly discussed elsewhere herein, a first set of multiple labels may be associated with a first item or portion of content and a second set of multiple labels may be associated with a second item or portion of content, where the first set and the second set may include completely different labels, the same labels, or certain common labels and certain different labels.

A feedback generation component may be configured to provide feedback to content sources reflective of such contributions. A contribution score or other indicator may be generated using such determination for respective items of content used for training. The feedback may comprise the contribution score, grade, or other such contribution indicator, a percentage contribution to the LLM adjustment of parameters, and/or a token (e.g., a financial payment, an access code to one or more online resources (such as an LLM), or other item of value) reflective of the contribution to the LLM training and/or output (e.g., reflective of the contribution score). As discussed elsewhere herein, tokens may be transmitted to a user via email, a messaging service, a downloaded application on a user device or otherwise. The token may be transferred to a user account (e.g., a financial account).

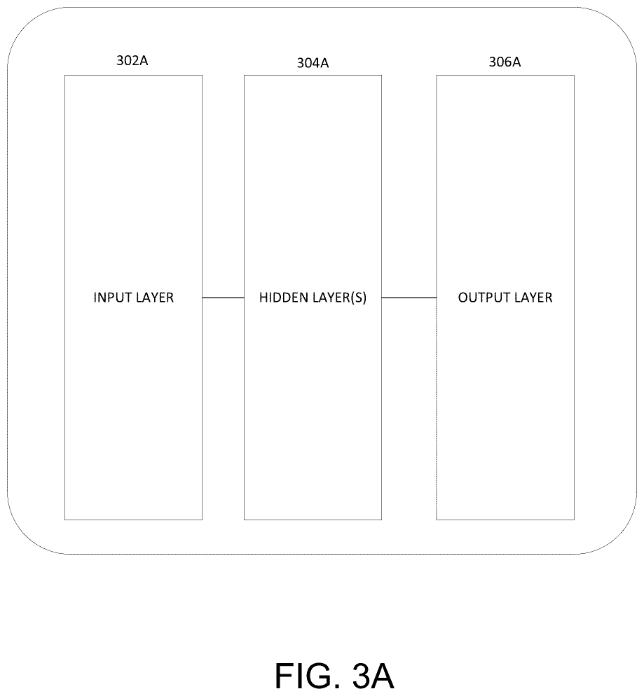

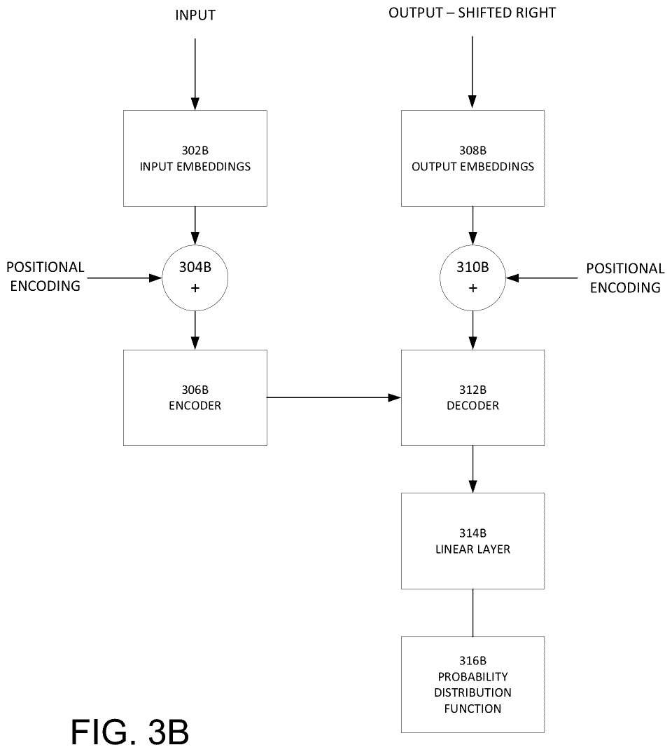

An example of a neural network configured to generate responses to user queries/prompts, such as that described herein, is illustrated in FIG. 3A. The neural network may also be utilized to analyze a generative model output to determine the source and/or contribution that items of training content made to the training and/or output of the generative model. The neural network may be utilized in a transformer model, such as that described herein.

The neural network may contain an input layer 302A, one or more hidden layers 304A, and an output layer 306A. The hidden layers 304A may be configured as convolutional layers, pooling layers, fully connected layers and/or normalization layers. For example, the neural network may be configured with one or more pooling layers that combine outputs of neuron clusters at one layer into a single neuron in the next layer. Max pooling and/or average pooling may be utilized. Max pooling may utilize the maximum value from each of a cluster of neurons at the prior layer. Average pooling may utilize the average value from each of a cluster of neurons at the prior layer.

The training data (e.g., text, image, or audio) may comprise data scraped from one or more websites, from one or more databases, or may be obtained from other sources. For example, the training data may be submitted, via a user or computer interface, by one or more content source systems via which content for training may be uploaded or via which a link to content for training may be provided. Training content may also be accessed from sources of content in the public domain (e.g., having expired copyright protection or that has been affirmatively placed in the public domain).

The neural network may be trained using a supervised or unsupervised process. The neural network layer node weights may be adjusted using backpropagation based on an error function output with respect to the accuracy/relevance of the content generated and/or selected by the neural network, to thereby lower the error. The changes of weights may be recorded in memory as the neural network is being trained by respective items of training content. Such recorded changes in weights may be used to generate feedback as similarly discussed elsewhere herein.

A transformer model may be utilized to generate and/or select content for a user as part of a generative model (e.g., an LLM or other generative model). In addition, a transformer model may be utilized to analyze the output of another generative model, such as an LLM. Referring now to FIG. 3B, an example transformer model architecture is illustrated.

Block 302B is configured to receive tokens (a sequence of characters or subwords that represent a single unit of meaning within the input text) and generate input embeddings, where the input text is converted into a numerical format, sometimes referred to as input embeddings. The input embeddings represent words as numbers so as to be suitable for machine learning model processing. During training, the model learns how to create such embeddings so that similar vectors represent words with similar meanings.

Positional encoding may be utilized to encode the position of a given word in the input sequence as a set of numbers. The set of numbers may be input to transformer model 304B, in association with the input embeddings, to enable the model to understand the order of words in a sentence and generate grammatically correct and semantically meaningful output.

A neural network encoder 306B processes the received text and generates a series of hidden states that encapsulate the text context and the text meaning and that represent the input text at different levels of abstraction. Optionally, there may be a plurality of encoder layers. Optionally, the encoder tokenizes the input text into a sequence of tokens (e.g., words or sub-words), and applies one or more serial attention layers, such as individual words or sub-words. Advantageously, such attention layers enable the transformed model to selectively focus on different parts of the input sequence rather than having to treat each word or sub-word the same way, and further advantageously, enables relationships between inputs significantly distanced apart in the sequence to be determined. Such determined relationships facilitate language processing tasks.

The decoder 312B may be trained to predict a next word in a text sequence based on the prior words. This is optionally performed in part by shifting the output sequence to the right so that the decoder is only using the earlier words.

The output is converted to a numerical format, which may be referred to as output embeddings 308B. Positional encoding is optionally performed to facilitate the transformer model understanding of the order of words in a segment (e.g., a sentence). The set of numbers may be input 310B. A loss function, configured to calculate the difference between the transformer model's predictions and the actual values, may be utilized to adjust the transformer model to improve accuracy by reducing the difference between predictions and targets, and hence the error. During training, the output embeddings may compute the loss function and update the transformer model parameters to improve the transformer model performance. During an inference process, the output embeddings may generate output text by mapping the model's predicted probabilities of a given token to the corresponding token in the vocabulary.

The decoder 312B may receive the positionally encoded input representation and the positionally encoded output embeddings and, based on the foregoing, generates an output sequence. There may be one or more layers of decoders 312B. During the training process, the decoder learns how to predict the next word by examining the prior words. The decoder 312B may generate natural language text based on the input sequence and the context learned by the encoder.

A linear layer 314B may map the output embeddings from the decoder 312B to a higher-dimensional space to thereby transform the output embeddings from the decoder 312B into the original input space. A probability distribution function, 316B, such as the softmax function, may be applied to the output of the model's final layer, producing a vector of scores representing the likelihood of each possible output token in the vocabulary given the input sequence. The function may map these scores to a probability distribution over the vocabulary, with higher scores corresponding to higher probabilities.

By converting the output of the model into a probability distribution, the probability distribution function enables the transformer model to produce a prediction for the next token that is both informed by the input sequence and consistent with the language's syntax and semantics. This allows the model to generate fluent, coherent text that reflects the structure and style of the input text.

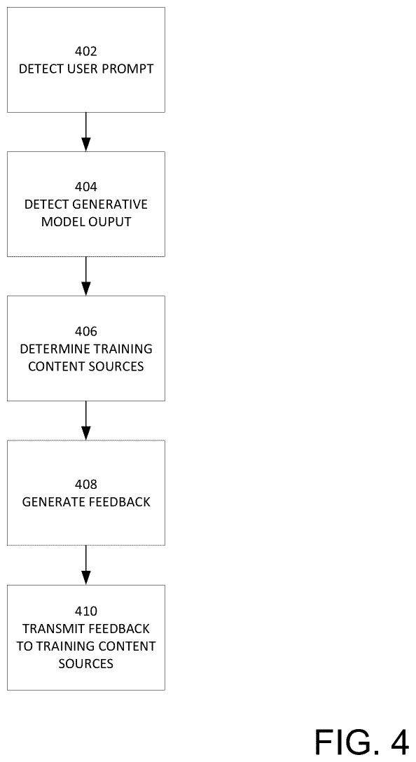

Referring now to FIG. 4, an example process is illustrated. At block 402, a user prompt (which may be in the form of a query or instruction) provided to a generative model (e.g., LLM, an AI image generator, a multimodal model, described herein) is detected. For example, the prompt may be detected by examining a server log generated by a receiving server, server side scripting, and/or middleware. At block 404, the generative model output responding to the user prompt is detected.

At block 406, the sources of the training content and the contribution a given item of training content has made to the output and/or model training may be determined. For example, as similarly discussed elsewhere wherein, examination of training content labels, modification to model weights, and/or an analysis of the generative model output (e.g., via prompt engineering, stylometric analysis, domain related analysis, or otherwise) may be performed. For example, stylometric analysis may be performed on the generative network output to determine an author (who may also be the source) of an item of training content and/or the contribution of the item of training content to the generative model output using a Support Vector Machine, a Random Forest, a probabilistic algorithm, deep learning techniques (e.g., recurrent neural networks, long short-term memory network, or the like), a K-Nearest Neighbors algorithm, and/or ensemble methods. The determination may be stored in memory, optionally in association with the generative model output, for later use.

At block 408, feedback reflective of the contributions made by items of training content may be generated, optionally in substantially real time (e.g., 0.5 second-5 seconds) or at a later time (e.g., when system utilization is otherwise low, such as below a certain threshold). The feedback may be generated using the determinations made at block 406, which may be accessed from memory. The feedback may be in the form of aggregated and/or individual label weights associated with respective items of content, a percentage contribution to the adjustment of generative model parameters, a score or grade reflective of the contribution to the generative model output, and/or a token (e.g., a financial payment, an access code to one or more online resources (such as to a generative model), or other item of value) reflective of the contribution to the training and/or output of the generative model.

At block 410, the feedback is provided to the content sources. The feedback may be transmitted in substantially real time and/or a scheduled time (e.g., once a day, once a week, once a month, and/or once a year). The feedback may be transmitted via email, a messaging service, a downloaded application on a user device and/or otherwise. A token provided as feedback may be transferred to a user account (e.g., a financial account). Such feedback may incentivize the content source to provide additional and/or high quality content for future training.

It is understood that although the foregoing example process assumes that items of content from content sources were used to train a generative model, the estimated contribution of one or more content items to a given item of generated content may be independent of the technology or techniques used to generate the generated content. Thus, for example, without knowing what technology or model was used to generate a given item of generated content, stylometric analysis may be performed on the generated content to determine an author or source of an item of content that is estimated to have contributed to the generated content.

By way of illustrative example, the estimated contribution (e.g., percentage contribution) a given item of content made to the generated content may be determined using a Support Vector Machine, a Random Forest, a probabilistic algorithm, deep learning techniques (e.g., recurrent neural networks, long short-term memory network, or the like), a K-Nearest Neighbors algorithm, and/or ensemble methods, as similarly discussed elsewhere herein. Although such estimates of contribution may not be infallible, they may be sufficiently accurate so as to adequately estimate such contributions with satisfactory accuracy. The estimates may be a percentage contribution score that mimics the human perception of how much an item of content contributed to an item of generated content, although the techniques used to mimic such perceptions may be vastly different than that used by a human. Feedback may be assigned in a pro rata manner based at least in part on the estimated proportional or percentage contribution for various items of content to an item of generated content. Such feedback may be provided as similarly discussed above and elsewhere herein with respect to feedback for content used to train a generative model. For example, such feedback may include a contribution score, grade, or other such contribution indicator, an estimated percentage contribution to the item of generated content, and/or a token (e.g., a financial payment, an access code to one or more online resources (such as an LLM), or other item of value) reflective of the contribution to the generated content (e.g., reflective of the contribution score). As discussed elsewhere herein, tokens may be transmitted to a user via email, a messaging service, a downloaded application on a user device or otherwise. The token may be transferred to a user account (e.g., a financial account).

An LLM is a probabilistic model trained in a probabilistic manner. Hence, a single attribution determination technique may not provide a sufficiently accurate attribution determination. Thus, as similarly described elsewhere herein, multiple attribution techniques may be utilized, where respective weighting may be utilized for the different techniques, For example, as discussed below, a likelihood score generated by an LLM (which indicates how a target relates to potential source documents), a cosine similarity score (which may be used to indicate the similarity between word embeddings or document embeddings), and/or a Token Frequency (TF) score may be used in combination to determine source attribution. Optionally, the scores generated by the different techniques may be differently weighted (e.g., based on their determined reliability and/or accuracy).

By way of background and as similarly discussed elsewhere herein, word embeddings are representations of words in a continuous vector space, where words with similar meanings or contexts are closer to each other in the embedding space. Word embeddings may be learned using techniques such as GloVe (Global Vectors for Word Representation), FastText, and/or contextualized embeddings, such as BERT (Bidirectional Encoder Representations from Transformers). Optionally, a given word in a vocabulary is associated with a vector (e.g., a fixed-size dense vector) capturing semantic and syntactic properties of the word based on its context in the training data.

Once the tokens are converted into embeddings, they may be aggregated into a single representation for an entire sentence. Such aggregation may be performed using one or more methods such as averaging, summing, recurrent neural networks (RNNs), or transformers. After aggregation, a single embedding/vector representation (e.g., of length 2048 or other length) may be obtained for the entire sentence.

Document embeddings represent entire documents or paragraphs as dense vectors in a continuous space. These embeddings capture the semantic meaning or content of the document and may be used for tasks such as document classification, clustering, or retrieval. Example techniques for generating document embeddings include averaging word embeddings (e.g., using models such as Doc2Vec, or using pre-trained models such as BERT or Universal Sentence Encoder).

Image embeddings represent images as dense vectors in a continuous space, where similar images are closer to each other in the embedding space. These embeddings capture visual features and semantic information about the images and may be utilized in tasks such as image similarity search, object detection, or image classification. Techniques for generating image embeddings include using pre-trained convolutional neural networks (CNNs) such as VGG (Visual Geometry Group that comprises blocks, where a given block comprises 2D Convolution and Max Pooling layers), ResNet (Residual Network, a deep learning model comprising hundreds or thousands of layers, in which the weight layers learn residual functions with reference to the layer input), or MobileNet (a series of convolutional layers, followed by depthwise separable convolutions, inverted residuals, bottleneck design, linear bottlenecks, and squeeze-and-excitation (SE) blocks) to extract features from images.

By way of further background, “closest cosine similarity match” refers to finding the most similar items based on their cosine similarity score. Cosine similarity is a metric used to measure the similarity between two vectors of an inner product space. In particular, closest cosine similarity match measures the cosine of the angle between them, which indicates how closely aligned the vectors are. An aspect of the present disclosure relates to using cosine similarity to determine the similarity between word embeddings or document embeddings.

With respect to word embeddings, a given word in a vocabulary is represented as a dense vector in a high-dimensional space (word embedding space). The vocabulary may be associated with a fixed-size dense vector, capturing semantic and syntactic properties of the word based on its context in the training data. A fixed-size dense vector comprises a data structure that represents a collection of numerical values of fixed length. An element in the vector may correspond to a specific feature or dimension of the data being represented.

Cosine similarity can be used to compare the similarity between two word embeddings (vectors). Words that are semantically similar or appear in similar contexts tend to have higher cosine similarity scores. Similarly, entire documents or sentences can be represented as vectors in a high-dimensional space using document embedding techniques such as averaging word embeddings or using models (e.g., Doc2Vec or BERT). Cosine similarity can then be used to compare the similarity between two documents or sentences.

To find the “closest cosine similarity match,” the cosine similarity between a target vector (e.g., a word, document, or sentence embedding) and other vectors in the dataset may be calculated. The item with the highest cosine similarity score may be considered the closest match.

For example, the process may calculate the cosine similarity between the embedding vector of the word “resigned” and the embedding vectors of the other words in the vocabulary. The word with the highest cosine similarity score may be considered the closest match, indicating the word that is most similar to “resigned” in terms of its embedding representation.

With respect to TF, the token frequency itself may be used directly or TF-IDF Weighted Averaging may be utilized. Utilizing this technique, a given word embedding is weighted by its TF-IDF score (Term Frequency-Inverse Document Frequency) before averaging. The TF-IDF score reflects the importance of a word in the context of the entire document corpus. Weighting the embeddings by TF-IDF provides more weight to words that are both frequent within a given sentence and rare across the entire corpus, potentially capturing more meaningful information.

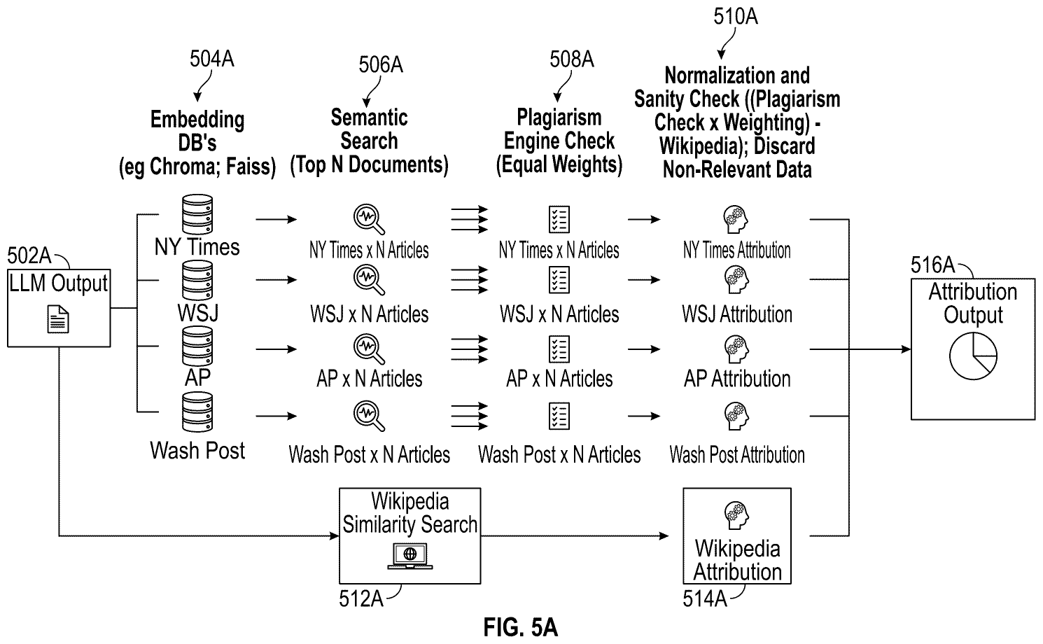

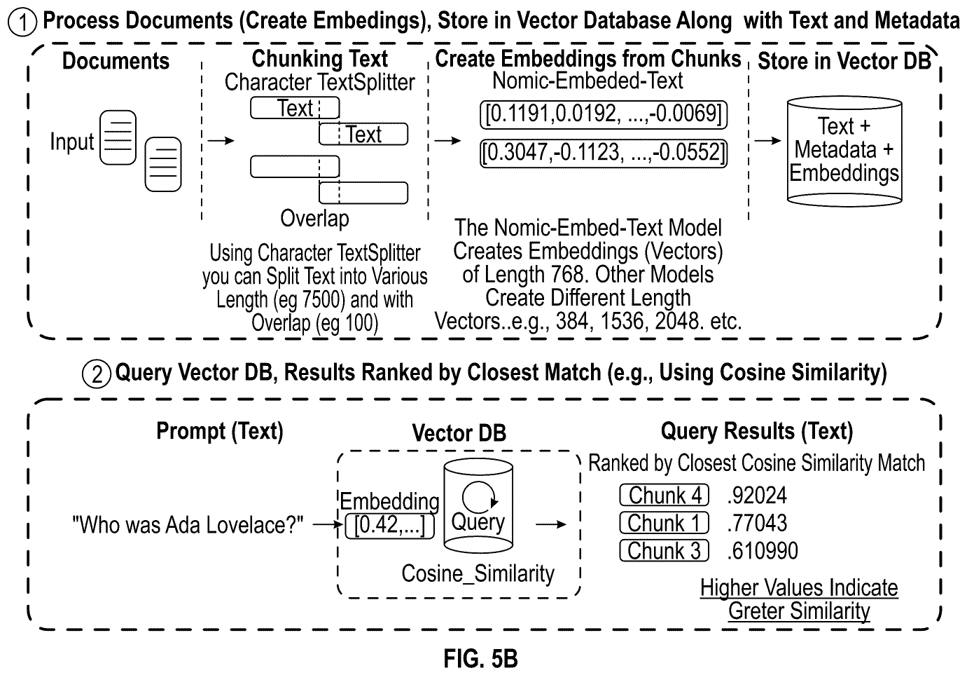

By way of background, referring to FIG. 5A, an example architecture of a text-based attribution engine is illustrated. The text-based attribution engine may include or have access to one or more embedding databases 504A which may be used to store content (e.g., articles, books, papers, etc.) where a determination may be made as to whether an LLM response 502A to a prompt relied on one or more of such items of content in generating an output, and hence, whether an attribution credit or token should be given to the content item owner or author. Optionally, a given embedding database 504A may include content items from multiple sources (e.g., multiple publishers). Optionally, separate embedding databases 504A may be created for respective content sources (e.g., media publications). Optionally, the embedding database(s) may be continuously updated with new content items from one or more sources, optionally in real time.

Advantageously, the embedding database 504A is configured to store embedding vectors in a compact and efficient manner to reduce or minimize storage space requirements. Because embedding vectors are typically high-dimensional (e.g., hundreds or thousands of dimensions), such efficient storage and compression techniques may be employed to greatly reduce memory storage utilization. The embedding databases 504A may use indexing structures and algorithms optimized for similarity search, such as approximate nearest neighbor (ANN) search algorithms. ANN algorithms enable efficient and high speed retrieval of items that are close in embedding space to a given query item. The embedding database 504A may be configured to handle large-scale datasets containing millions or billions of embedding vectors. The embedding database 504A may be configured with a distributed architecture that can scale horizontally across multiple nodes or machines to accommodate growing datasets and increasing query loads.

The LLM output 502A (generated in response to a user prompt) may be used to perform a semantic search 506A to determine the most relevant items of contents that are contained within the embedding database(s).

A plagiarism and/or similarity check 508A may be performed using the LLM output and the identified most relevant items of content (which may be retrieved from a content database) to generate an initial attribution score.

Optionally, a false attribution checker 510A may be utilized to determine if attribution can be made to other public sources or more than a threshold number of other sources. If a determination is made that attribution can be made to other public sources or more than a threshold number of other sources it may be indicative that it is difficult to determine the original source of the content used to generate the LLM output, and hence, what source is entitled to attribution. If the uncertainty is greater than a threshold, optionally no attribution may be made (and hence no token or credit may be provided), or attribution may be assigned to multiple potential sources (and the corresponding token or credit may be divided amongst and provided to the multiple sources). For example, the content items may be compared against a search of potential sources using a search engine to find matching items of content. By way of illustration, a similarity search 512A may be performed against a common reference source, such as WIKIPEDIA. A determination may be made as to how much/what percentage of the LLM output 502A can be attributed to the common reference source, which may in turn be used in determining the attribution assigned to the other sources (e.g., by weighting the contribution to the common reference source).

Referring to FIG. 5B, an example architecture and process for identifying the closest matches to a prompt/query. Content items (which may be generally referred to as documents) may be processed to generate embeddings. The document text may be chunked. For example, the text of the document may be split into chunks of one or more lengths (e.g., 5000 characters, 7500 characters, 10,000 characters) where a given chunk may optionally partially overlap a previous chunk (e.g., 50, 100, 200, or 300 characters). Embeddings (vectors) may be generated from the chunks. For example, the vectors may have a length of. 384, 768, 1536, or 2048. The vectors may then be stored in a vector database (e.g., an SQL database).

The vector database may then be utilized as follows. A text prompt may be converted to an embedding (a vector). The prompt embedding may then be compared to the vectors in the vector database by calculating respective cosine similarity scores (where the higher the score the greater the similarity). The cosine similarity scores may be ranked, and the closest matching chunks may be identified (as well as the documents from which the chunks were extracted).

The sources of training data for the training of an LLM whose output is used to create speech (e.g., using a TTS engine) may be similarly determined, with an initial step of converting the audio speech to text, and then determining the training sources as described herein with respect to LLM output text. Credits/tokens may be accordingly assigned to the sources based on their contributions.

The sources of training data for the training of a neural network TTS or other waveform synthesis engine may be determined using one or more techniques, and credits/tokens may be accordingly assigned as similarly described with respect to assigning credits/tokens based on the output an LLM that generates text.

While neural TTS systems do not explicitly copy training data, certain characteristics of the training data (such as speaker idiosyncrasies, prosody, and accents) may be reflected in the generated audio. Forensic audio analysis techniques maybe utilized to analyze specific features of the audio and to determine a contribution of audio training content to the output. For example, spectral analysis may be utilized to analyze the frequency spectrum for patterns that might indicate that training content utilized. Optionally, voice biometrics may be utilized to identify specific vocal traits that may match a particular speaker.

Optionally, watermarking may be utilized to trace the training data and to identify the training data source. For example, watermarks or signatures may be embedded into the generated audio (e.g., speech) during a training phase by modifying the training process so that certain subtle, imperceptible markers are included in the output. The watermarks can then be detected in the output audio.

By way of further example, specific patterns or noise may be introduced into the model's training process that are likely to appear in the output and can serve as identifiers.

Credits/tokens may be assigned based on the contribution of a given contributor to the training and/or output of a text, video, and/or audio generator.

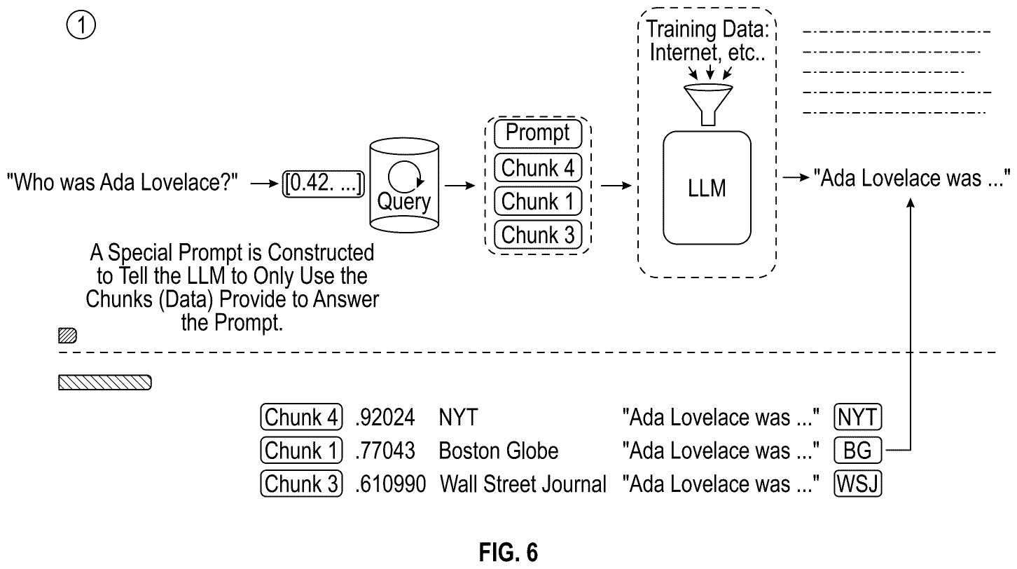

With reference to FIG. 6, a special prompt may be constructed so as to instruct an LLM to only use specified provided chunks (data) to respond to the prompt. The chucks may be from respective different sources (e.g., different media publishers). For example, a prompt may be converted to an embedding and the special prompt may be constructed. The special prompt (including the chunks from different sources) may then be input to the LLM (which has been trained using training data from one or more sources). The LLM response to the prompt may be accessed and compared to the chucks to determine the similarity of the LLM output to the specified chunks. For example, the similarity of the LLM output to the chunks from respective sources may be determined using cosine similarity, TF, and/or an LLM as similarly discussed elsewhere herein. Attribution (and optionally corresponding tokens and/or credit) may be assigned to the source whose chunk has the highest similarity score.

Optionally, tokens and/or credit may be proportionally assigned to sources based on the similarity scores. Optionally, such proportional assignment may only be provided to sources whose score exceeds a specified threshold. Optionally, a record may be made of the similarity calculation and the corresponding attribution and assigned tokens/credits. Such record may be later accessed (e.g., to perform an audit process on attributions, and token/credit assignments). Thus, logs may be kept for some or all of the determinations discussed herein and may optionally be distributed to one or more content sources (e.g., optionally in conjunction with attribute determinations and associated token distributions).

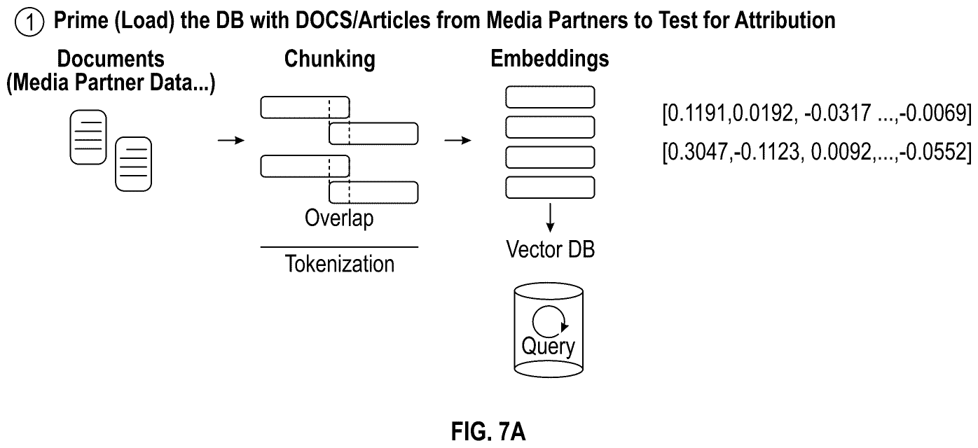

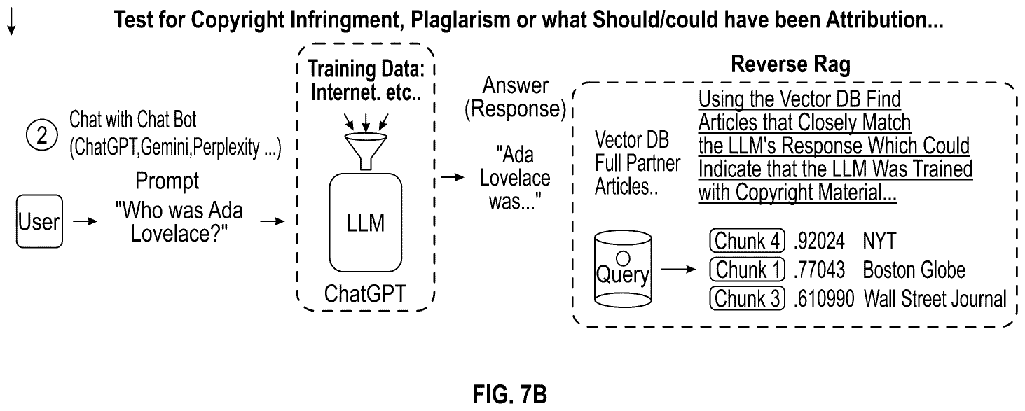

FIGS. 7A, 7B illustrate another example attribution architecture and process. Documents from one or more sources may be accessed. As similarly discussed, above, the text of the documents may be chunked. For example, the text of a given document may be split into chunks of one or more lengths (e.g., 5000 characters, 7500 characters, 10,000 characters, or other number of characters) where a given chunk may optionally partially overlap a previous chunk (e.g., with an overlap of 50, 100, 200, or 300 characters). Embeddings (vectors) may be generated from the chunks. For example, the vectors may have a length of. 384, 768, 1536, or 2048. The vectors may then be stored in a vector database (e.g., an SQL database).

With reference to FIG. 7B, a user may provide a prompt to a trained LLM (e.g., trained using data accessed from the Internet, one or more databases, or other sources). The output of the LLM may undergo a reverse retrieval-augmented generation (RAG). RAG may involve using an information retrieval system to search external knowledge sources (such as documents, databases, and/or other sources) for information relevant to a user's prompt/query. An LLM may utilize the retrieved information to contextually enrich its process of generating responses.

In particular, RAG may involve the following states. A user prompt (e.g., query) may be received. The RAG system searches for relevant documents (e.g., from the Internet, proprietary databases, and/or the like) that might answer the question. These documents may comprise public or proprietary data, and may be stored in a document index. The RAG system creates an LLM prompt that combines the user input, the related documents, and instructions for the LLM to answer the user's question using the documents provided. The RAG system may provide the LLM prompt to an LLM. The LLM returns a response to the user's query, which may be at least partly based on the provided context.

A reverse RAG may receive the LLM output to the user prompt and use the vector database to identify documents that closely match the LLM's response and to generate similarity scores for respective document chunks (e.g., using cosine similarity, TF, an LLM or other techniques as discussed elsewhere herein). The similarity scores may be utilized to assign attribution (and optionally corresponding tokens and/or credit) to the source whose chunk has the highest similarity score. Optionally, as similarly discussed elsewhere herein, tokens and/or credit may be proportionally assigned to sources based on the similarity scores. Optionally, such proportional assignment may only be provided to sources whose score exceeds a specified threshold. Such attribution may also be utilized to detect potential copyright infringement.

Optionally, a record may be made of the similarity calculation and the corresponding attribution and assigned tokens/credits. Such record may be later accessed (e.g., to perform an audit process on attributions, and token/credit assignments). The record may indicate what portions (which may be referred to as claims) of a given LLM output were determined to be supported by a given document.

Optionally, in order to reduce computer resource utilization, rather than compare an LLM output to all documents in a document database, the number of documents for which such comparison is made may be filtered down to only documents from specific sources (e.g., partner publishers with an account with the attribution system) and/or from a specific time frame. Optionally, the database itself may be limited to content from partners who affirmatively agreed to have their content stored in the database and used for source determinations and/or to content from open-source depositories that permit the free and unrestricted use of its open-source content,

As discussed elsewhere herein, multiple techniques may be utilized in determining attribution for a given LLM output (and different portions of the output, such as short statements, which may be referred to claims), where the different determinations may be different weighted (e.g., to reflect their respective reliability and/or accuracy). For example, a percentage likelihood that a given document was used to train the LLM may be calculated using the results of the multiple determination techniques. By way of illustration, the following formula may be utilized to generate such percentage likelihood that a given document was used to train the LLM:

Likelihood=F(w1S1+w2S2+ . . . +wn−1Sn−1+wnSn)
F=Function that converts summed weighted scores to percentage likelihood content was used to train the LLM
W=weighting factor
S=score generated by respective technique (e.g., LLM, TF, cosine similarity, and the like)

Optionally, the percentage likelihood that a given document was used to train the LLM needs to exceed a specified threshold (e.g., 0%, 66%, 75% or other percentage) in order for attribution be assigned to the document (and in order for tokens/credits be provided to the document source).

Optionally, a voting scheme may be utilized, wherein the document identified as the most likely source by a majority of the attribution techniques will be provided the attribution (and optionally, corresponding tokens/credits). Thus, for example, if an attribution LLM and a cosine similarity calculation both indicate that Document 1 is the most likely source for an output of an LLM (and hence used to train the LLM) and the TF technique indicates that that Document 2 is the most likely source for the output of the LLM (and hence used to train the LLM), because the majority of techniques indicates that Document 1 is the source, Document 1 may be provided with the attribution (and the owner of Document 1 may be provided with tokens/credits).

Optionally, the amount of credits/tokens provided to a determined document for an LLM output may be based on both the attribution and on the percentage of the LLM output that the document contributed to. For example, if there was a 100% attribution made to a given document (meaning it is certain that the document was used in training the LLM to generate the LLM output), but the document only contributed to 1% of the LLM output, only a relatively small amount of tokens (e.g., a relatively small payment) may be provided to the document source. If, on the other hand, there was a 70% attribution made to a given document, but the document contributed to 40% of the LLM output, a relatively larger amount of tokens (e.g., a relatively larger payment) may be provided to the document source. Optionally, tokens set aside for registered contributors of content (e.g., registered content publishers) for a given LLM response (or LLM training) may be equally or unequally (e.g., based on actual or relative contribution) divided amongst such registered contributors for which attribution was made, even if the contribution of a given item of content (or the total contribution of all partners' content) is very small on a percentage basis (e.g., 1%, 0.1%, etc.).

Optionally, an attribution score for a document determined to be a source for an LLM output may be boosted based on the size of a literal quote from document (e.g., fragment level, sentence level, paragraph level, etc.) found in the LLM output, as in the following formula:

Adjusted attribution score=attribution score×Function(size of literal quote).

It is understood that multiple sections/portions of a given document may be evidenced in the LLM. Optionally, the assignments of tokens to a document source may be based in whole or in part on the number of sections attributed.

Optionally, an attribution score for a document determined to be a source for an LLM output may be boosted based on the number times the document was determined to be a source for LLM outputs. Optionally, an attribution score for a document determined to be a source for an LLM output may be boosted based on positive feedback from users for previous prompt responses for which the document was determined to be the source. For example, optionally when a prompt response is presented to a user, it may be presented in association with a feedback control, such as a like/dislike control, a helpful/not-helpful control, or a rating interface (e.g., where the user can provide a rating of 1 to 5 indicating how useful/helpful the response). Such feedback may be tracked and stored in memory, and used to determine whether a given document or document source is to have their attribution score boosted in the future, and the amount of the boost.

A content source whose documents have received more than a certain threshold of such positive feedback may be designated as a reliable source in the source's account record. The system may generally boost attribution scores with respect to documents from such designated reliable sources. Similarly, a source whose documents have received more than a certain threshold of negative feedback (e.g., dislike, not helpful indications) may be designated as an unreliable source in the source's account record. The system may generally reduce attribution scores with respect to documents from such designated unreliable source. Optionally, a ranking of sources may be generated using such user feedback and the ranking may be used in selecting sources for content used to train LLMs.

Optionally, to prevent or detect feedback from a content source masquerading as feedback from an actual user from being used in boosting an attribution score for the content source, the IP address associated with received feedback may be examined and a determination may be made if a large amount of feedback corresponding to content from a given source is coming from the same IP address and is coming at a frequency that appears to indicate that the feedback is being generated by an automated script. If the feedback is determined to be or likely to be from the content source or from an automated script, adverse action may be taken, such as excluding documents from the content source from being used to train LLMs or having its attribution scores decreased by a percentage or amount.

Optionally, an attribution score for a document determined to be a source for an LLM output may be adjusted based on the uniqueness of the information from the document found in and supporting the LLM output. For example, if similar information is found in multiple other documents (e.g., WIKIPEDIA, newspaper databases, etc.), the attribution score may be decreased. If, on the other hand, the information is unique or fairly unique (where the same or similar information is not been located elsewhere), the attribution score may be increased.

Optionally, if two or more documents have similar attribution scores for a given portion of an LLM output, the two or more documents may be examined to determine if they contain the same text, indicating that one document may be the original source of the text, and the other document(s) may have copies of such text. If the documents contain the same text, publication dates for the respective documents may be accessed (from the document metadata or from a publication date provided by the content publisher) and attribution may be assigned to the document with the earliest publication date.

Optionally, if a given document from a given source was itself accused of copyright infringement or subject to a take-down notice (indicative of an infringement claim), further attribution scores for documents from that source may be reduced by a certain amount or percentage as a penalty indicative of the reduced confidence that a document from that source is original and hence deserving of attribution. Optionally, a threshold number of claims over a specified period of time may need to be detected in order for such reduction in attribution score to be performed.

Although certain aspects herein discuss determining attribution of text, in addition, attribution of style of an LLM output (e.g., provided in response to a user prompt) may be determined for an LLM text output or image output. Tokens may be provided to a creator (or owner of the creations) when a LLM output has a corresponding style attribution to the creator as similarly discussed herein with respect to text attributions.

For example, each person has a unique set of vocabulary the person tends to use in writings. By way of illustration, a given writer may tend to use certain words or phrases and tend not to use other words or phrases. Such tendencies may be consistent across multiple documents. As will be discussed, a process may be utilized to analyze the style of writings and the style of the output of an LLM to determine if a style from one or more documents has been used in the LLM output. For example vocabulary choice, sentence structure, grammar and punctuation, tone and voice, themes and topics, and/or rhetorical devices may be used to generate a style signature of a writer and that signature may be used to determine if there is a matching style signature in the LLM output.

Thus, the process may analyze the frequency of certain words or phrases to characterize an individual's writing style. The process may analyze certain characteristics of sentences, such as sentence length, complexity, and/or structure. By way of illustration, such sentence characteristics can vary significantly from one writer to another writer. For example, some writers tend to utilize short, concise sentences, while other writers may tend to utilize longer, more complex constructions. Analyzing the patterns of sentence structures can help identify a writer's style.

The use of punctuation marks, grammar rules, and writing mechanics can also contribute to a writer's style. By way of illustration, some writers may tend to use punctuation sparingly (reflective of a more casual or conversational tone), while other writers may adhere more closely to grammatical rules for punctuation (reflective of a more formal style).

The style of a writer may also be influenced by the writer's tone and voice (e.g., humorous, serious, formal, informal, scientific, etc.). Identifying recurring tones or voices in a writer's writings may be utilized in generating the style signature.

Writers may tend to employ specific rhetorical devices, such as metaphors, similes, analogies, and rhetorical questions. A writer's style signature may be based at least in part on the identification of such rhetorical devices.

Optionally, a neural network, such as described herein, may be trained and utilized to classify certain aspects of a writer's style.

Similarly, a style signature may be generated for a given artist (e.g., a painter, an illustrator, or the like) based on an analysis of various elements of their artwork, such as subject matter, technique, mediums, composition, color palette, texture and surface, symbolism and iconography, historical and cultural influences, and/or signature or markings. Some artists may include a signature or specific markings on their artwork, which can aid in identification. A learning engine, such as a neural network, may be utilized to analyze artworks and classify the various foregoing elements. Such classifications may then be utilized to generate a signature associated with a particular artwork of an artist or for the artist's overall style.

By way of illustration, artists may tend to depict certain subjects or themes (e.g., landscapes, portraits, still life works, abstract concepts, and/or particular animals or objects, etc.) indicative of an artist's style. By way of further illustration, the artist's techniques (e.g., brushwork, line quality, shading, use of color, and/or the like) contribute to their artistic style. By way of additional illustration, the choice of medium (e.g., oil paint, watercolor, charcoal, digital, mixed media, and/or the like) may be characteristic of an artist's style.

An artist's composition tendencies (e.g., the way an artist arranges elements within their artwork, such as the placement of objects, figures, and the overall balance of the composition), may be characteristic of an artist's style. By way of further illustration, a given artist may tend to utilize a signature color palette or use certain colors in unique ways that become recognizable in their work. Thus, the hues, tones, and color combinations an artist employs may be utilized in generating an artist's style signature. By way of further illustration, a given artist may tend to employ certain textures and/or surfaces (e.g., impasto (thickly textured paint), smooth blending, a combination of impasto and smooth blending, and/or or collage elements) which may be used to generate an artist's signature.

By way of further illustration, a given artist may tend to employ certain symbols, shapes, motifs, and/or iconography in their work which may be utilized to generate an artist's signature. Some artists may include a signature or specific markings on their artwork, which can aid in identification and may be used in generating an artist's style signature.

Optionally, to distribute the workload of gathering LLM outputs to large numbers of user devices (rather than requiring a large centralized system with large numbers of servers), a browser plug-in may be installed on the browsers of user devices. For example, a user may be utilizing a browser to access a user interface of a remote LLM. The user may insert a prompt into a prompt field of the user interface which may then be transmitted from the browser to the LLM. The LLM may generate a prompt response which then may be transmitted to and displayed by the user interface on the user device. The browser plug-in may provide a control which when activated causes the LLM prompt response to be transmitted to the attribution engine for source analysis. The results of the source analysis may be transmitted to the sources for which attribution was determined. Additional example uses and operations of the browser plug-in are discussed elsewhere herein.

Optionally, a system may be provided via which a publisher (a provider of content) may request (which may be referred to as an inclusion request) that its content be used to train a given LLM and/or included in an LLM output provided in response to a user prompt. Optionally, the system may transmit a user interface to a publisher device that includes fields and/or controls via which a publisher can target such request to specific user prompt categories, prompt keywords, and/or types of users.

For example, the system may comprise an auction system, wherein a publisher may bid (e.g., an amount of money or other token) to have their content used to train a given LLM and/or included in an LLM output provided in response to a user prompt. The publisher may be provided information on a given potential placement (e.g., an opportunity to have publisher content used to train an LLM or have publisher content included in a response to a user prompt), such as user prompt category, prompt keyword, and/or types of user associated with a potential placement to enable the publisher (or a bidding system operating on behalf of the publisher) to determine which potential placement to bid on, and how much to bid. The winning publisher bid (which may optionally be the highest bid) may be determined, and designated content from the publisher whose bid won may be utilized to train the LLM and/or the winning publisher's content may be included in a response to the user prompt.

For example, the auction system may include a prompt analysis engine that is optionally configured to analyze user prompts and determine the subject category of the prompt. The prompt analysis engine may optionally be configured to identify keywords and phrases in the user prompt.

The bidding system may optionally be configured to perform user profiling. For example, the bidding system may gather and analyze user characteristics (e.g., demographics, preferences, behavior). The user may have provided such user characteristic data via a profile user interface and/or such information may be obtained from databases (e.g., third party databases).

The bidding system may include a bidding platform that provides an auction interface to a publisher system (the auction interface may comprise an API to enable a publisher computer system to automatically submit bids and/or a user interface via which a user may submit a bid). The auction interface may enable publishers to place bids on specific subject categories, keywords, and/or user characteristics.

The bidding system may include a bid management system that manages bids, including setting minimum bid amounts, bid increments, and bid expiration times.

The bidding system may include a content matching engine that executes a matching algorithm that matches user prompts with the most relevant content based on bid amounts, content relevance, and/or user profile. Optionally, recency of a given item of content may be utilized in evaluating relevancy and hence in selecting publisher content for training an LLM and/or for inclusion in a prompt response. Optionally, if a given publisher has been accused on one or more instances of infringement (e.g., via a takedown notice), an adjustment factor may be utilized to reduce the relevancy score/determination of that publisher's content. A content repository may store the content from publishers in a database.

The bidding system may include a delivery system and/or LLM training system. The delivery system may compile selected content from the publisher who had a winning bid into a coherent response to the user prompt. The response may be transmitted over a network to and presented by the user device to the user. The LLM training system may train an LLM using selected content from the publisher who had a winning bid (e.g., using training techniques described herein). The trained LLM may then be utilized to generate a response to the user prompt, and the generated response may be transmitted over a network to and presented by the user device to the user.

The performance of the content (e.g., user engagement, satisfaction, and/or the like) may be monitored by the system and provided as feedback to publishers.

An example process may be executed as follows. A user submits a prompt or query to the system. For example, the prompt query may be provided by the user via a user interface presented by a user device. The prompt may then be transmitted by the user device over a network to the system. The system analyzes the prompt to determine the subject category, extract keywords, and/or consider any available user characteristics. A bidding process may then be performed. Publishers may have pre-set bids for specific subject categories, keywords, and/or user characteristics. When a prompt is received from the user device, the system identifies relevant bids. An auction is held to determine which publisher's content will be provided. This can be a real-time auction or use pre-determined bid values.

The content matching engine selects the highest bid that meets the relevance criteria. Relevance may be determined based on bid amount, content quality, and/or how well the content matches the prompt and user profile.

The selected content is integrated into the response to the user prompt or is used to train an LLM, which in turn generates the response to the user prompt. The response is then transmitted over the network to the user device. The user device may then present the response to the user. The response may include a link (e.g., a URL) to the publisher's content.

Additional aspects of content-based auctions are discussed elsewhere herein.

The system may execute a feedback loop. For example, the system may track user interactions with the content. Metrics such as click-through rates, time spent on content, and/or user feedback are collected. This data may be used to refine the bidding process and improve content matching over time.

Following is an example scenario:

User Prompt: “What are the benefits of a hybrid car?”

### Prompt Analysis:

Subject Category: Automotive and Environmental

Keywords: “benefits”, “hybrid car”

User Characteristics: Conservation, frequent reader of green energy articles

### Bidding Process:

Publishers A, B, and C have bids for Automotive & Environmental.

Publisher A bids $0.05 per prompt, Publisher B bids $0.10, and Publisher C bids $0.08.

Publisher B's content is more relevant based on the prompt analysis.

### Content Matching:

Publisher B wins the bid with $0.10 and relevant content about the hybrid cars.

### Response Delivery:

The system generates a response incorporating Publisher B's content and delivers it to the user via the user device and/or uses Publisher B's content to train an LLM which then generates a response which is delivered to the user via the user device.

### Feedback:

The user engages with the content positively, leading to higher satisfaction scores. This feedback may be logged and stored in memory by the system, helping to optimize or enhance future auctions and content matches.

Thus, the content inclusion auction system ensures that users receive relevant and high-quality content while enabling publishers to compete for visibility based on their content's value and relevance.

Optionally, rather than a publisher bidding on keywords, or matching an LLM prompt with keywords, the system may scrape a website of a content publisher and may determine whether the website includes documents/information that is relevant to the prompt. For example, an LLM or keyword matching may be utilized to determine if the website includes documents/information that is relevant to the prompt. If the website includes documents/information that is relevant to the prompt, the system may then use the relevant documents/information from the website in the output provided to the user in response to the user prompt. The content publisher may then be assigned tokens/credits as discussed elsewhere herein.

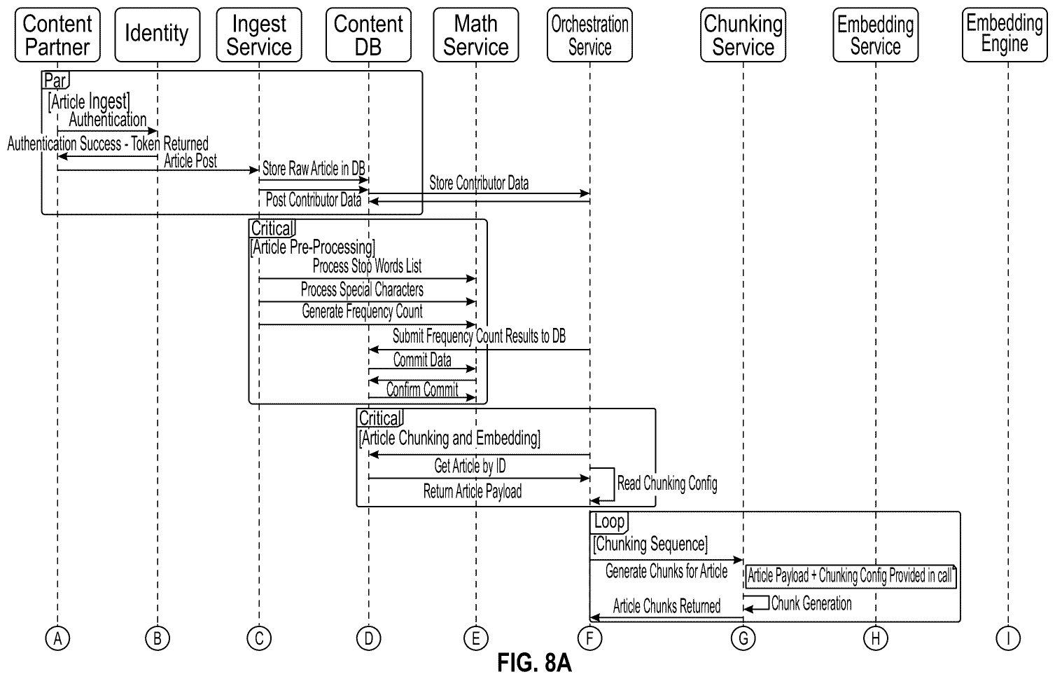

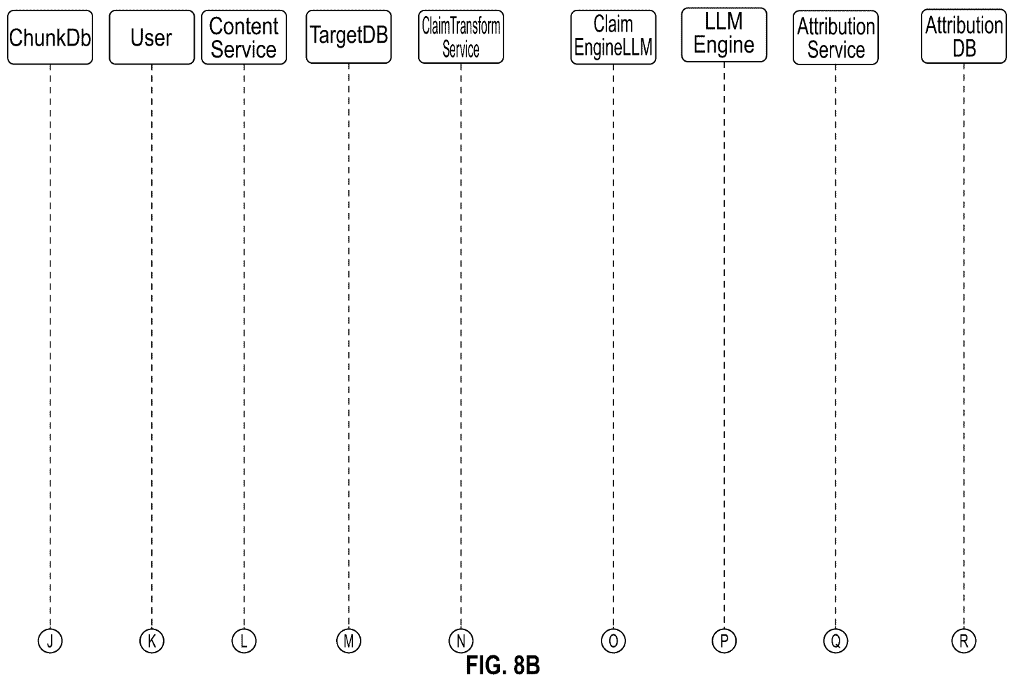

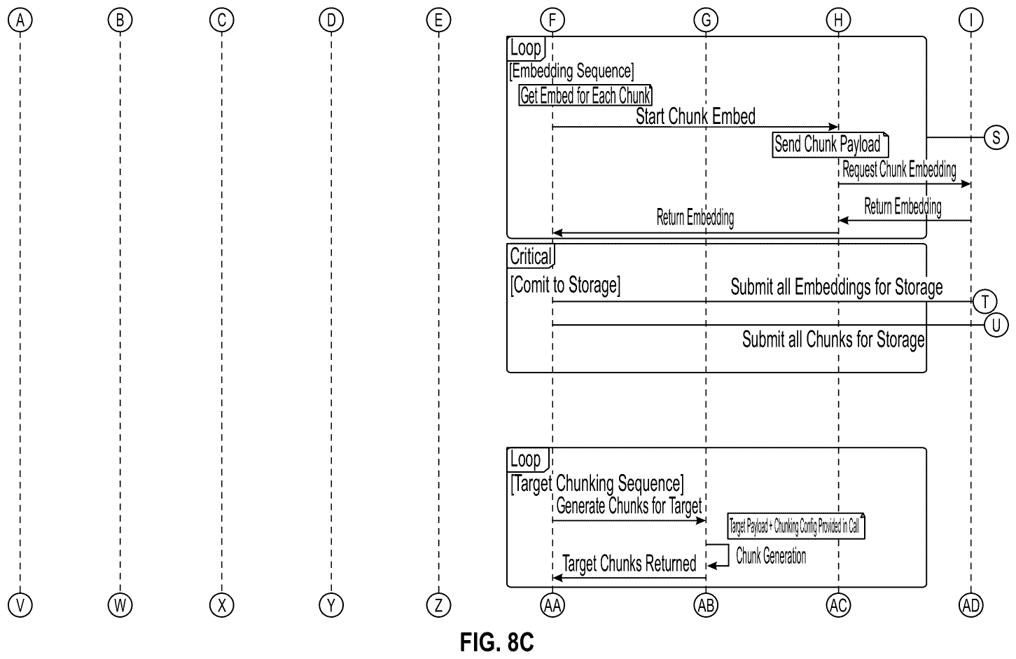

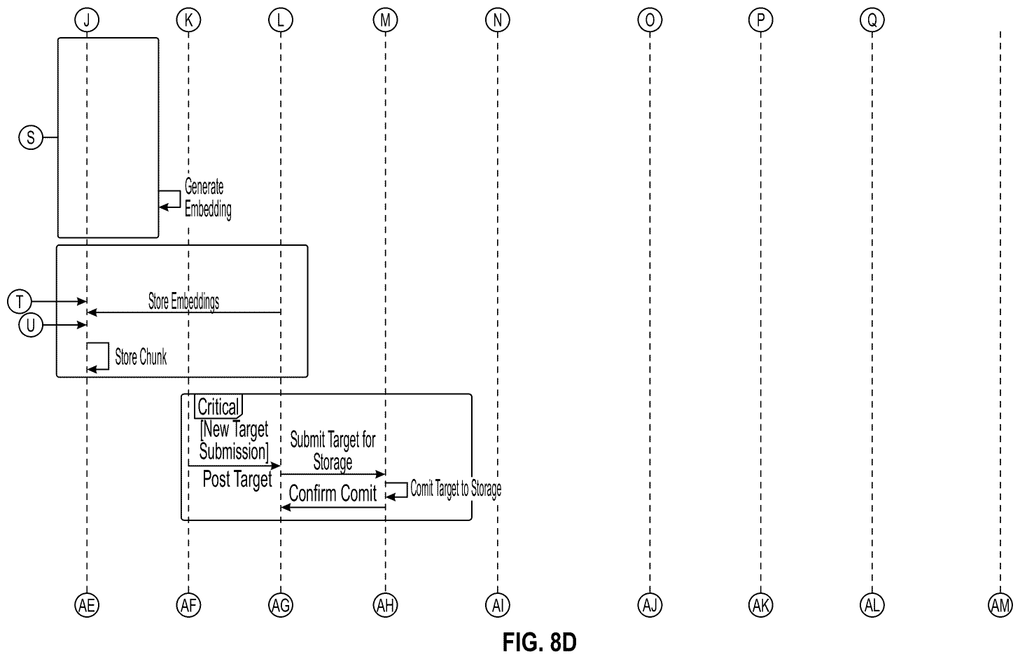

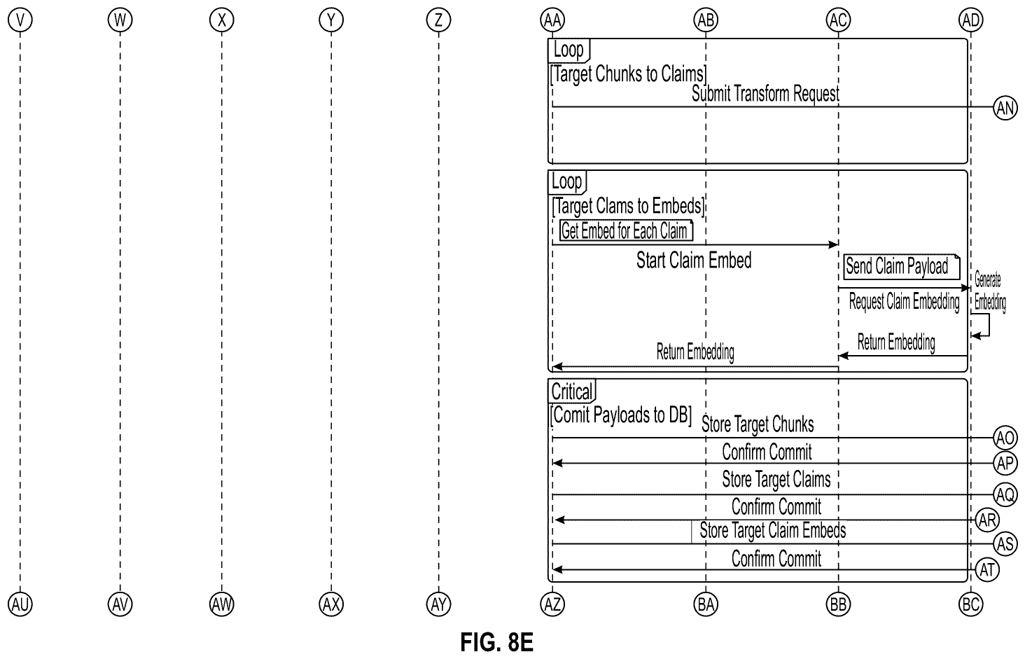

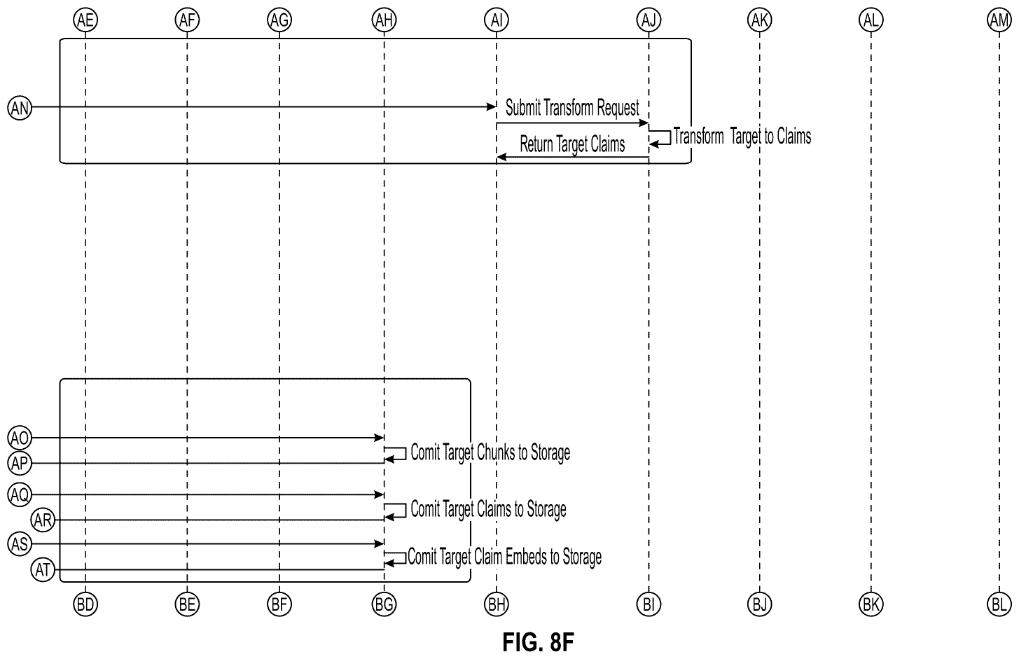

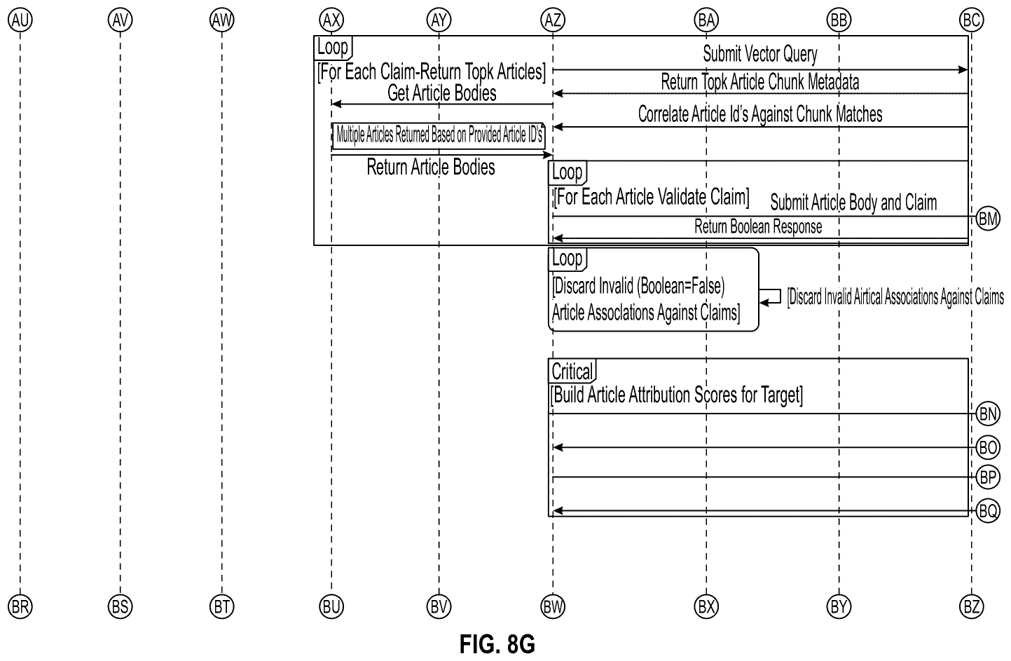

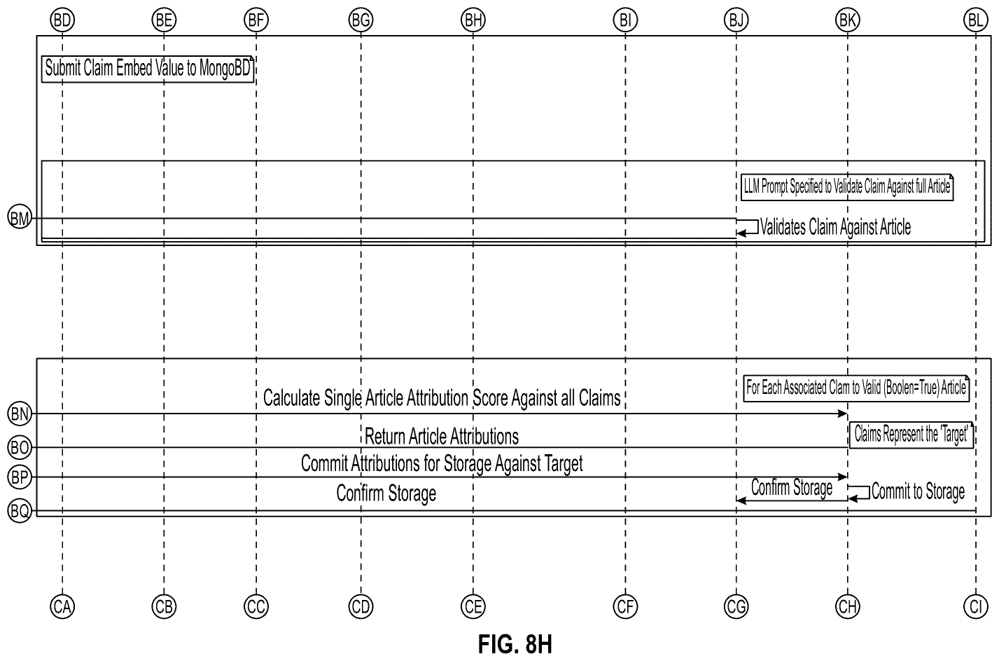

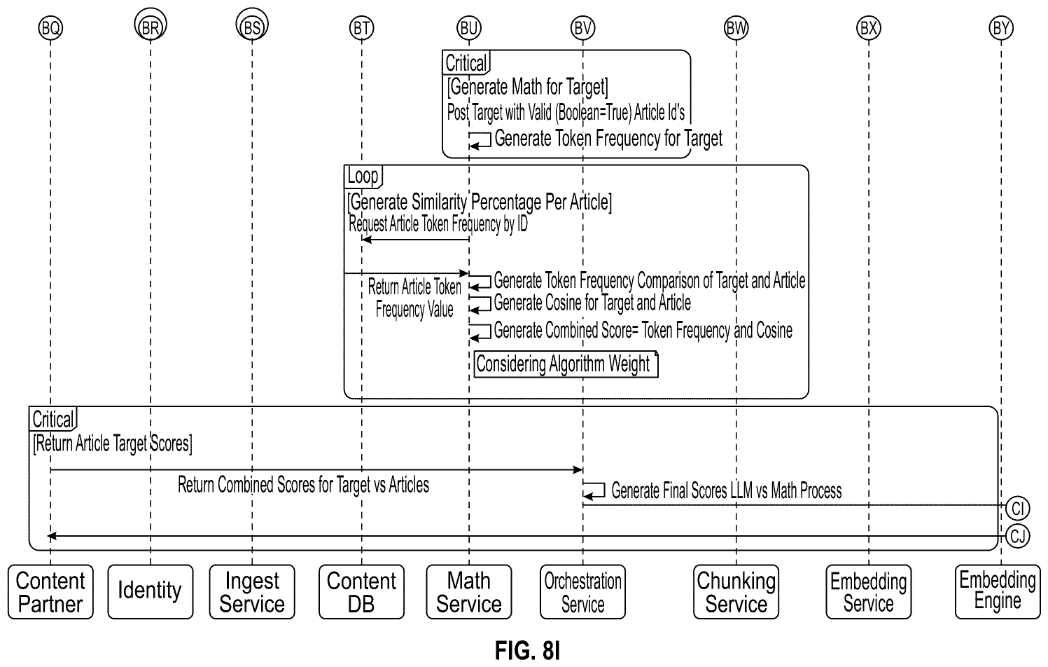

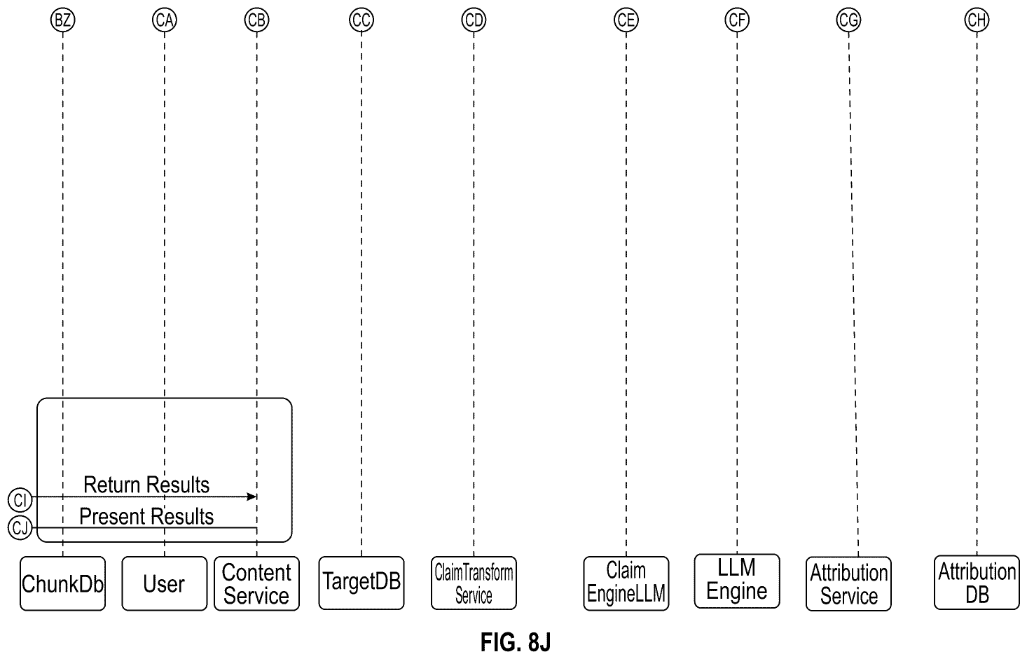

FIGS. 8A-8J illustrate an example process. The example process includes interactions amongst a content partner system, and identity service, an ingestion service, a content database, a math service, an orchestration service, a chunking system, an embedding service, an embedding engine, a chunk database, a user device, a target database, a claim transform service, a claim engine LLM, an attribution service, and an attribution database.

An article (which may be any type of document) may be ingested from a partner computer system (e.g., a computer system of a registered content publisher). The identification service performs an authentication process, and if the authentication process is successful, returns a token to the content partner system. The article may then be posted to the ingest service. The raw article may be stored in raw form in the content database and the associated contributor data may be posted and stored as well.

The ingested article may undergo preprocessing, including the processing of a stop words list and special characters (e.g., the removal of stop words and special characters that contain little or no useful information from the article). A corresponding frequency count may be generated. The frequency count may be submitted to the content database. A commit data instruction may be transmitted to the content database, and the content database may respond with a commit confirmation message. A commit ends a transaction within the database and enables other services and users to see the changes.

The article may be accessed by an associated identifier and an article chunking and an embedding process (where the process accesses the article via an associated article identifier) may be performed, and an article payload may be returned. For example, a loop may be executed wherein a get embed request is made for respective article chunks. By way of illustration, the text of the article may be split into chunks of one or more lengths (e.g., 5000 characters, 7500 characters, 10,000 characters) where a given chunk may optionally partially overlap a previous chunk (e.g., 50, 100, 200, or 300 characters). The chunk payloads may be transmitted to the embedding service in association with a request that chunk embeddings be generated. Embeddings may be generated from the chunks and returned. For example, the vectors may have a length of. 384, 768, 1536, or 2048. The vectors may then be stored in a vector database (e.g., an SQL database).

The chunks and chunk embeddings may then be stored in the chunk database.

A new target submission may be received (e.g., body of text being submitted to get an answer back) and submitted for storage in the target database. The target may be chunked by a target chunking sequence. For example, the target payload and chunking configuration may be provided in a call to the chunking service, which may return corresponding chunks. A transform request may be submitted to target chunks to claims. The claim engine LLM may transform the target to claims and may return the generated target claims.

An embedding may be generated from respective claims via an embedding loop. For example, the claims may be sequentially transmitted to the embedding service which returns the corresponding embeddings. The target chunks, target claims, and target claim embeddings may be stored in memory (e.g., a database).

For a given claim, corresponding matching articles may be returned (e.g., TopK articles, where TopK is a probabilistic data structure that the most frequent items in a data stream to be identified). For example, a database vector query (comprising a claim embed value) may be submitted, and TopK article chunk metadata may be returned. Article identifiers may be correlated against chuck matches. The article bodies may be returned. For a given article, the claim is validated against the article and a response (e.g., a true or false response) may be returned. Article association against the claims may be discarded.

For example, a claim embed value may be submitted to the database. The article identifiers may be correlated against chunk matches. The article bodies may be returned based on the provided article identifiers. The article bodies may be returned and for a given article, the corresponding claim may be validated by the LLM engine (where a determination may be made as to whether the claim is true; the claim represent the target). An LLM prompt may be specified to validate a given claim against the full article. For example, for a given associated claim for the claim to be valid (Boolean=True) article. Invalid article associations against claims may be discarded.

Article attribution scores for the target may be generated against the claims. Optionally, a single article attribution score may be calculated for some or all claims (where the claims represent the target). For example, for a given associated claim, for the claim to be valid (Boolean=True) article, and the claims represent the target. Article attributions are returned, and the attributions are committed for storage against the target.

Optionally, a token frequency may be generated for the target.

A similarity percentage per article may be generated. For example, a token frequency comparison of the target and the article may be generated, a cosine similarity value of the target and article may be calculated, and a combined score based on the weighted token frequency comparison and the cosine similarity value may be calculated.

Combined scores for target vs. articles may be returned, and final scores may be generated. The results may be returned and presented.

As described elsewhere herein, the contribution a given source may have made to a generative model (e.g., an LLM) output may be determined. Optionally, to reduce the processor and memory utilization that might be incurred by creating and submitting sample prompts (e.g., queries or instructions) to a generative model and then have the generative model generate a corresponding output in order to be able to evaluate the generative model output, large numbers of prompts of different users that are being submitted in the ordinary course of generative model usage and the corresponding generative model outputs may be utilized.

For example, as similarly discussed elsewhere herein, a browser plugin/extension may be added to large numbers of browsers of large numbers of users (unless the context indicates otherwise, the terms plugin and extension will be used interchangeably). The browser may be downloaded and installed from a browser plugin store or may come pre-installed on the browser. The browser plugin may be configured to identify prompts being submitted by a user to a generative model, identify the generative model the prompt is being submitted to, and identify the generative model output generated in response to a given prompt. The prompts, the identity of the generative model, and the corresponding generative model outputs may be copied and transmitted to a remote source, such as generative model system 104 and/or other system configured to determine the source contribution of generative model outputs.

As similarly discussed elsewhere herein a feedback generation component may be configured to provide feedback to content sources reflective of such contributions. The feedback may comprise the contribution score, grade, or other such contribution indicator, a percentage/pro rata contribution to the generative model adjustment of parameters, and/or a token (e.g., a financial payment, an access code to one or more online resources (such as a generative model), or other item of value) reflective of the contribution to the generative model training and/or output (e.g., reflective of the contribution score). Optionally, a user may be required to opt-in to installing the browser plug-in and/or the sharing of the user's generative model prompts and generative model prompt responses. Optionally, the user may receive a token (e.g., a financial payment, an access code to one or more online resources (such as a generative model), or other item of value) that may be reflective of the number of the user's generative model prompts and generative model prompt responses that has been shared over a given time period (e.g., a week, a month, a year, a certain number of days, and/or the like). A user record may be maintained, wherein such sharing quantities and an indication of tokens earned may be recorded.

By way of example, when a user is accessing a user interface via a webpage for submitting prompts to a generative model and for receiving generative model outputs, the browser plugin or extension may be configured to identify user input fields (corresponding to a user prompt) and output fields (for the generative model output) using techniques involving the Document Object Model (DOM) and/or browser APIs (Application Programming Interfaces).

For example, the plugin may utilize JavaScript to access the DOM of the webpage by interacting with the HTML structure and identifying elements that are likely to be text fields or input fields.

Optionally, input fields may be identified by identifying HTML elements, such as <input>, <textarea>, and <select> elements, that are commonly used for user inputs. The plugin may search for these elements using document.querySelectorAll or similar DOM traversal methods. For <input> elements, the type attribute may be examined to aid in identifying specific kinds of fields (e.g., text, password, email, etc.). A placeholder attribute or associated <label> elements may be examined to aid in determining the purpose of a field. Output fields, configured to receive the output of the generative model, may also be similarly identified.

Once the prompt input field is identified, the plugin may attach event listeners to these input elements to track user inputs and other interactions. For example, the event listener may listen to input or change events, and upon detecting a user input into a prompt field and activation of a prompt submit control, the prompt entered by the user may be captured and transmitted to the system 104 and/or other system configured to determine the source contribution of generative model outputs.

The detecting and copying of the generative model prompt response may involve monitoring changes to the DOM after a user interacts with the page. By way of example, a content script (e.g., content.js) may monitor changes to the DOM and detect the generative model output. For example, as similarly discussed above, the HTML element where the generative model response is displayed may be determined by inspecting the webpage to find the correct element. DOM changes may be detected for such elements. Methods, such as navigator.clipboard.writeText in the browser extension or GM_setClipboard in a userscript, may be utilized to copy the detected text to a clipboard. The plugin may then transmit the generative model response to the system 104 and/or other system configured to determine the source contribution of generative model outputs.

The generative model being used may be determined by the plugin. For example, the browser plugin may examine the URL of the current webpage to identify the associated generative model based on known patterns or keywords associated with different generative models. Because generative model webpages generally have distinct URL patterns, by analyzing the current page's URL, a browser extension can infer which generative model is being used.

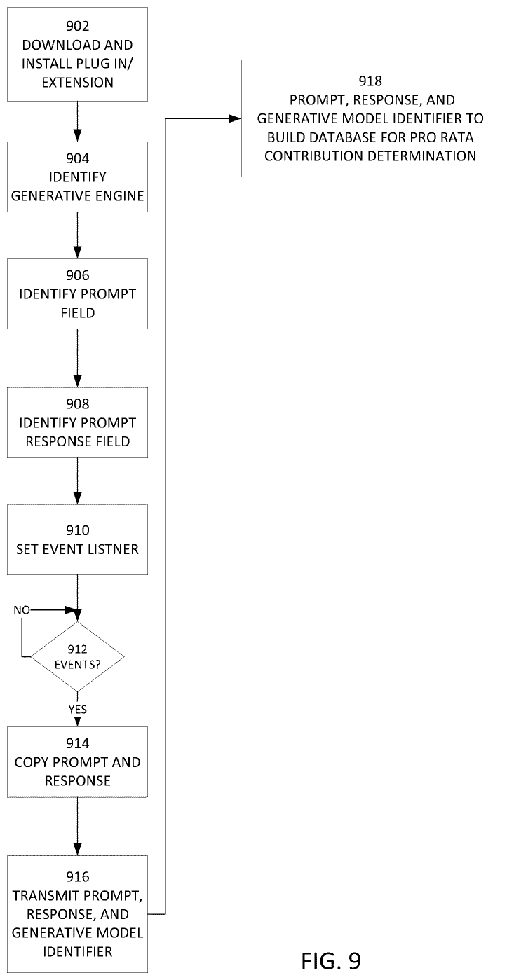

FIG. 9 illustrates an example process for utilizing a browser extension to obtain generative model prompts, generative model prompt response, and generative model identification information. At block 902, a browser extension is installed on a user hosted by a user device. The browser extension may have been downloaded from a browser extension library (e.g., hosted by the source of the browser), which may be in the form of an online extension store. Optionally, the browser extension or a webpage may prompt the user to opt-in to the collection of data related to generative model prompts and responses. If the user opts-in to the collection of such data, a corresponding indication may be stored in a user record and/or elsewhere, and the following process may be performed. If the user fails to opt-in to the collection of such data, a corresponding indication may be stored, and optionally the following process will not be executed.

At block 904, the browser, with the extension installed, accesses a webpage associated with a generative model (e.g., an LLM), and the browser extension is utilized to determine the identity of the generative model. For example, as similarly described elsewhere herein, the browser extension may examine the URL of the generative model webpage to identify the associated generative model based on known patterns or keywords associated with different generative models (e.g., wherein the name of the generative model or the like may be included in the URL). For example, a URL for a fictitious generative model called “ACMEGM” may have a URL of ACMEGM.COM. Optionally, the extension may transmit the URL to a remote system (e.g., an LLM system such as described herein) which may analyze the URL and determine that generative model being used.

At block 906, the browser extension determines a user prompt field in the webpage. For example, the extension may access the DOM of the webpage identifying elements that are likely to be text fields or input fields. As similarly discussed elsewhere herein, certain HTML elements may be utilized in a webpage to identify user input fields (e.g., <input>, <textarea>, <select> and/or the like). The browser extension may search for such elements using DOM traversal methods and/or the like. Once an element is identified that may be associated with a user input field, associated attributes may be analyzed to identify specific kinds of fields (e.g., a text field.). A placeholder attribute or associated <label> elements may be examined to aid in determining the purpose of a field (e.g., generative model prompt field). Optionally, a prompt submission control may be detected as well.

Similarly, at block 908, a prompt response field may be identified in the webpage, configured to receive the generative model's output provided in response to the user's prompt. For example, the webpage DOM may be accessed. Containers or elements configured to display the generative model's output may be identified. Elements that are to contain a prompt response may be identified via associated attributes (e.g., id, class, and/or the like). For example, IDs, classes, or attributes that indicate the purpose of the element, such as id=“results”, class=“output”, and/or the like may be identified. Containers such as <div>, <section>, or <ul>, often with classes such as results, may be identified.

At block 910, event listeners may be set on the identified prompt field, the prompt submission control, and/or prompt response field. The event listeners may be configured to detect when a user has entered text into the identified prompt field, when the user has activated the submit control, and/or when the prompt response field is populated with a response.

At block 912, a determination may be made as to whether the event listeners have detected a set of events that satisfy a rule. The rule may optionally require that certain events occur in a specified sequence. For example, the rule may specify that first a user entry of text into the prompt field needs to be detected, then an activation of the submit control needs to be detected, and then a population of the output field may need to be detected.

If the rule is satisfied, at block 914, the browser extension may copy the prompt and the generative model response. For example, a content script (content.js) may be utilized to copy text from the webpage.

At block 916, the identification of the generative model (e.g., in the form of all or part of the URL), the user prompt, and the generative model response may be transmitted to the remote system (e.g., the LLM system described herein).

At block 918, the remote system may add the received data to a database for later analysis and for use in determining the pro rata utilization of different sources of content in generating generative model outputs, as described elsewhere herein.

Optionally, the data (e.g., text data) collected by the browser extension may be anonymized prior to transmission to the remote system. For example, the browser extension may remove identifiers or data that may be used to identify a person (e.g., user ID, email addresses, names, phone number, physical address, place of employment, and/or the like) prior to transmission. Optionally, if what appear to be identifiers are needed (e.g., to be compatible with a database schema or a software application), actual identifiers may be replaced by anonymized or pseudonymous identifiers that cannot be traced back to the user. Optionally, regular expressions may utilize patterns to identify common types of personal identifiers. For example, patterns for email addresses, phone numbers, or dates of birth may be utilized. Optionally, Named Entity Recognition models may be used to identify personal identifiers in the text.

Optionally, in order to preserve anonymity, data from multiple users may be aggregated together to a level where individual inputs are not distinguishable.

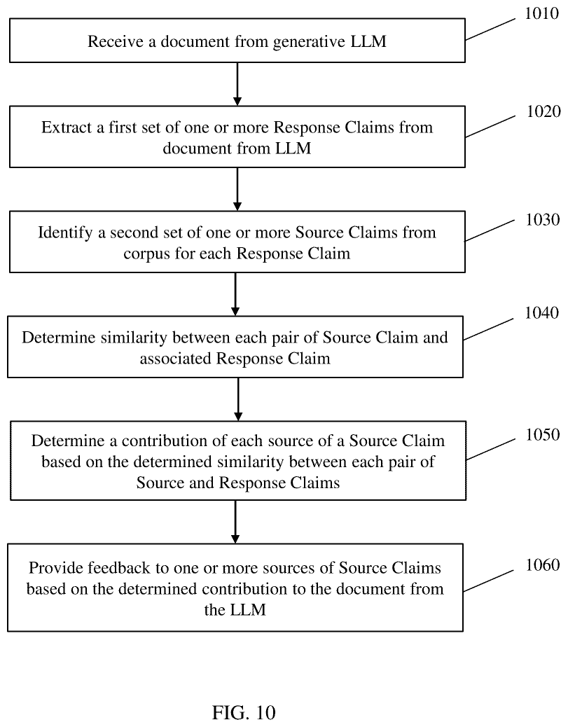

Illustrated in FIG. 10 is a flow chart of the process for determining the contribution of an existing document to a new document generated by an LLM, in accordance with an embodiment of the present invention. A new document generated by an LLM, for example, may incorporate elements of an existing document when the LLM is trained in part using the existing document. Based on the determined contribution, the owner of the training document and other content may be provided feedback as a form of recognition of the contribution to the document generated by the LLM. The contribution may be calculated and feedback provided based upon the corpus regardless of the LLM that generated the document, thus providing a robust mechanism for calculating the attribution to the numerous content providers from which the generative LLM was trained.

At block 1010, the processing device is configured to receive a “generated” document from a generative LLM. The generated document generally includes text, but may also include images, graphics, video, audio, and/or music, for example. The generated document may take the form of a text document, a multimedia document, a webpage, search results, or summary of search results, for example.

In the case of a text document, for example, the text may include a paragraph or a “chunk” that recites the following: “In addition to its economic benefits, education also has a profound impact on an individual's quality of life. Studies have shown that educated individuals tend to live longer, healthier lifestyles. For example, a report from the CDC's National Center for Health Statistics found that people with a bachelor's degree or higher live about nine years longer than people who don't graduate high school [5]. Moreover, education empowers individuals by providing self-determination, self-confidence, resilience, and motivation, leading to greater happiness and life satisfaction [3]. This is supported by research from various universities, including Oxford University, University of Arizona, and University of California Davis, which suggests that learning is a key ingredient of happiness and thriving.”

In the preferred embodiment, the generated document from LLM comprises text in the form of a plurality of paragraphs, sentences, snippets, and/or “chunks”. At block 1020, the processing device is configured to extract a first set of one or more “response claims” from the generated document. In this scenario, the response claims extracted by the processing devices consists of one or more sentences, each sentence comprising a statement, assertion, or declaration made by or about entities, events, concepts in a given context. In general, response claim may be characterized as either (i) a factual claim stating factual information or (ii) an opinion claim stating an opinion, judgement, or belief. In the case of text document reciting the paragraph above, for example, the response claim may consist of a sentence or statement that reads, for example, that “[e]ducated individuals tend to live healthier lifestyles”.

In other embodiments, the document received from the LLM comprises one or more images and/or one or more audio files. In the case of images, the set of one or more responsive claims may take the form of features extracted from the images or audio. In the case of an image, a feature may identify one or more people, objects, or places depicted in the image. In the case of an audio file, a feature may take the form of a person's voice or speech, the sound of an object, or the words or melody of a song, for example.

At block 1030, the processing device is configured to identify a second set of one or more “source claims” from the corpus of documents from which the LLM was directly trained or from documents from which the LLM was indirectly trained. The corpus generally includes thousands, if not millions, of documents with text, each document including one or more claims, namely factual claims and/or opinion claims. The second set of one or more source claims are claims extracted from the corpus based on their similarity to one or more response claims identified above. A source claim may consist of, for example, a sentence or statement such as “[w]hen countries support greater educational attainment, their citizens are healthier. This statement is similar to, and support of, the response claim that “[e]ducated individuals tend to live healthier lifestyles”. Moreover, the source claim likely contributed-either directly or indirectly—to the response claim asserted in the text document generated by the LLM.

While the example immediately above pertains specifically to text documents, source claims may also recite features of images in the training corpus used to train the LLM. Similarly, the source claims may recite features or characteristics of audio files used to train the LLM

In block 1040, the processing device is configured to determine the semantic similarity between each source claim and an associated Response Claim. The semantic similarity between a source claim and response claim may be dependent on (i) the similarity between the combination of words or phrases of the two claims, (ii) the similarity between the concepts of the two claims, or (iii) the similarity between the meanings conveyed in the two claims. The meaning of a claim may be determined, for example, based on a word graph that graphically represents the collection of words, concepts, and meanings in terms of link weights that associate respective words and concepts depicted in a sentence.

At block 1050, the processing device is configured to determine a contribution of each content provider of a source claim based on the determined similarity between each pair of source and response claims. Based on the similarity determined above, for example, the processing device is configured to determine the level or degree to which each source of training data has directly or indirectly contributed or benefited the LLM that produced the generated document responsive to a user enquiry. A first source claim may recite the following, “[a] relationship between education and health at a country level implies a similar relationship at an individual level.” This claim provides support for the assertion that “[e]ducated individuals tend to be healthier.” Similarly, a second source claim may recite the following, “[b]eing healthier implies living healthier lifestyles.” This claim provides support for the for the assertion that “[e]ducated individuals tend to live healthier lifestyles.” Based on an analysis of the respective word graphs, it can be determined that the first source claim has a similarity of value, S1, to the response claim while the second source claim has a similarity value, S2, to the response claim.

In block 1060, the processing device is configured to provide feedback to one or more content providers or other sources of source claims based on the contribution to the generated document from the LLM. If, for example, there where only two source claims associated with response claim recited above, then the processing device is configured to provide feedback to the first source and second source based on the percentage contribution of each respective source claim to the final response claim. That is, the first source is provided feedback based on prorate contribution, S1/(S1+S2), while the second source is provided feedback based on the prorate contribution, S2/(S1+S2). Assuming S1/(S1+S2) is equal to percentage P1 and S2/(S1+S2 is equal to percentage P2, then the first source is provided feedback in proportion to P1 while the second source is provided feedback in proportion to P2.

As similarly discussed elsewhere herein, a given content source may want their content to be used in training generative models and in generative model outputs (e.g., provided in response to user prompts). Hence, optionally the disclosed system may enable content sources to bid (e.g., using token) to have their content so utilized. The system may transmit context information to the sources to aid them in determining when and how much to bid (e.g., how many tokens to bid). As similarly discussed elsewhere herein, the context information may include keywords, subject categories corresponding to the user prompt (e.g., where example categories may include financial matters, professional sports, entertainment, health, clothing, food, restaurants, travel, and/or the like), or user characteristics (e.g., location, age, include, educational level, marital status, purchase patterns, and/or the like). As similarly discussed elsewhere herein, a prompt analysis engine may optionally be configured to identify keywords and phrases in the user prompt. Optionally, the user prompt may be transmitted to the sources to enable the source to determine whether to bid and/or how much to bid to have their content used, by the generative model, in generating a response

For example, a content source may select keywords (e.g., relevant to their products or services) and bid on these keywords. The bid may represent how much the sources are willing to pay per generative model output. Keywords may have different match types (e.g., exact match, phrase match, broad match, and/or the like) that determine how closely the search query needs to match the keyword. Thus, for example, one or more keywords may be compared against a user provided prompt to determine if the content source should bid to have their content used by a generative model in generating a prompt response.

Optionally, in addition to the bid amount a quality score may be assigned to a bid to have a source's content used by the generative model. The relevance of a source's content to the user prompt may be used as a bid multiplier in ranking bid amounts. For example, if a source's content is determined not to be generally relevant to a user prompt, the source's bid may be multiplied by a fraction that is less than one (e.g., 0.33) to thereby reduce the bid amount for purposes of determining a bid ranking and the winning bid (although the actual bid amount due does not change). If, on the other hand, the source's content is determined to be generally relevant to a user prompt, the source's bid may be multiplied by a multiplier that is greater than one (e.g., 1.4).

Thus, optionally, the combination of the bid amount and quality score may be utilized to determine the bid rank. Optionally, the content source the providing the highest ranked bid may have their content used in the prompt response.

As discussed above, content sources may choose specific categories that are relevant to their content. This helps in targeting users interested in particular types of content subject matters (e.g., related to categories of information, products and/or services). User prompts may be matched with relevant categories and content. Optionally, the system may enable content sources to set different bids for different categories or contexts.

Natural Language Processing (NLP) techniques, pattern recognition, and/or machine learning models may optionally be utilized to assign a category to a user prompt. Optionally, the prompt may be pre-processed before using it to determine the category of a user prompt. For example, tokenization (where the prompt may be split into individual words or tokens, lowercasing (wherein words are converted to lower case to standardize the text), stopword removal, and/or lemmatization/stemming may be performed.

The keywords (e.g., the main words in the prompt) may be identified using one or more techniques. Named Entity Recognition (NER) may be utilized to identify significant entities such as the names of people, the name of organizations (e.g., corporate or other entity names), the names of locations (e.g., the name of cities/towns, countries, and the like, and/or specific dates in the prompt.

Optionally, the user's intent may be predicted and classified. For example, rule-based based techniques may be utilized. For example, prompts starting with “how” are likely to be informational, while those with verbs like “buy” are likely be transactional.

Optionally, trained models (e.g., Support Vector Machines (SVM), Decision Trees, and/or neural networks) may be utilized classify the intent based on past labeled queries.

Topic/domain classification may be performed using the determined key elements and intent. For example, TF-IDF (Term Frequency-Inverse Document Frequency) may be utilized to calculate the importance of each word in the query relative to a set of known topics or categories. By way of further example, a topic modeling technique, such as Latent Dirichlet Allocation (LDA), may be utilized to identify probable topics based on the distribution of words in the query. Optionally, trained large language models (e.g., BERT, GPT, or custom models) may be used to predict categories for specific types of prompts (e.g., classifying a query into technology, health, finance, etc.). Optionally, ontology matching may be performed, words in the query are matched to predefined ontologies or taxonomies, such as categories on a news website (e.g., sports, politics, science).

As similarly discussed elsewhere herein, a given content source may target the use of their content in generative model outputs using user characteristics. For example, a content source may target its content to users based on user demographics such as age, gender, income, location, educational level, and/or the like. By way of further example, behavioral targeting may be performed wherein users may be targeted based on their past behavior, interests, and browsing history.

Thus, content sources may submit bids for keywords and set targeting criteria (e.g., user demographics, interests). When a user submits a prompt via a generative model user interface, the user prompt may be copied by the web browser extension, transmitted to a remote system, categorized as to subject matter, and a corresponding auction process may be triggered. The system may evaluate eligible content based on various criteria, such as bid amount, quality score, and/or targeting criteria.

Content may be ranked according to a combination of bid amount, quality score, and/or the like (or equivalent metrics). The winning content is used to generate a response to the user prompt via the generative model. The auction process may optionally be performed in real time.

Although, to facilitate the description of certain techniques disclosed herein, the above descriptions may refer to user provided prompts as being text prompts, the prompts may be in the form of images, or a combination of text and images. Similarly, although the above descriptions may refer to generative model outputs as being text outputs, the outputs may be in the form of images, or a combination of text and images.

Thus, an aspect of the present disclosure relates to methods and systems that provide enhanced generative model performance and control and track generative model training content. A further aspect of the present disclosure relates to providing feedback to training content sources. Such feedback optionally enhances the future provision and quality of generative model training content.

An aspect of the present disclosure relates to a computer system, the computer system comprising: a network interface; at least one processing device operable to: detect a prompt from a user device provided to a generative model; detect a response to the prompt, output by the generative model; estimate a contribution of a first item of content, used to train the generative model, to the generative model output; generate feedback based at least in part on the estimated contribution of the first item of content, used to train the generative model, to the generative model output; and transmit, using the network interface, the feedback generated based at least in part on the estimated contribution of the first item of content, used to train the generative model, to the generative model output to one or more networked destinations.

Optionally, the system is configured to estimate contribution percentages of a plurality of content items to the generative model output and to transmit corresponding pro rata feedback to respective sources of items in the plurality of content items. Optionally, the generative model comprises a large language model. Optionally, the generative model comprises an image generator. Optionally, the generative model comprises a transformer model comprising a neural network encoder and a neural network decoder, the neural network encoder comprising an input layer, an output layer, one or more hidden layers, and a max pooling layer. Optionally, the system is operable to estimate the contribution of the first item of content, used to train the generative model, to the generative model output based at least in part on labels associated with the first item of content, changes in weights of the generative model caused at least partly by training of the generative model using the first item of content, and/or based on an analysis of the output of the generative model. Optionally, the system is operable to estimate the contribution of the first item of content, used to train the generative model, to the generative model output using a neural network, a Support Vector Machine, a Random Forest, a probabilistic algorithm, and/or a K-Nearest Neighbors algorithm. Optionally, the feedback comprises label weights associated with labels assigned to the first item of content, an identification of a contribution to an adjustment of a weight of the generative model, and/or a token. Optionally, the feedback corresponds to the number of label weights associated with labels assigned to multiple items of content and/or the label percentage of the total number of labels for a given content item.

Optionally, estimating the contribution of the first item of content to the generative model output further comprises estimating a style contribution of the first item of content to the generative model output. Optionally, the computer system is operable to: chunk text of at least a first document into a plurality of overlapping chunks; generate embeddings comprising vectors corresponding to the plurality of overlapping chunks; and store the embeddings corresponding to the plurality of overlapping chunks in a vector database. Optionally, the computer system is operable to: generate a prompt instructing the generative model to use only specified document chunks in providing a response to the generated prompt; receive a response to the generated prompt from the generative model; and determine similarities of the response to the generated prompt to the specified document chunks. Optionally, the computer system is operable to adjust an attribution score for at least one content source based at least in part on user feedback with respect to generative model outputs generated using content from the at least one content source.

Optionally, the estimated contribution of the first item of content to the generative model output comprises an estimated contribution of vocabulary choice, sentence structure, grammar and punctuation, tone and voice, themes and topics, and/or rhetorical devices to the generative model output. Optionally, the estimated contribution of the first item of content to the generative model output comprises an estimated contribution symbols, shapes, motifs, and/or iconography to the generative model output. Optionally, the estimated contribution of the first item of content to the generative model output comprises an estimated contribution to one or more claims of the generative model output. Optionally, transmitting the feedback generated based at least in part on the estimated contribution of the first item of content to the generative model output to one or more networked destinations, further comprises transmitting feedback to a plurality of networked destinations based at least in part on estimated percentage contributions of a plurality of items of content to the generative model output. Optionally, the system is configured to transmit an aggregated feedback for a first period of time to the one or more networked destinations.

An aspect of the present disclosure relates to a computer-implemented method, the method comprising: detecting a response to a prompt output by a generative model; estimating a contribution of a first item of content, used to train the generative model, to the generative model output; generating feedback based at least in part on the estimated contribution of the first item of content, used to train the generative model, to the generative model output; and transmitting the feedback generated based at least in part on the estimated contribution of the first item of content, used to train the generative model, to the generative model output to one or more networked destinations.

Optionally, the generative model comprises a large language model. Optionally, the generative model comprises an image generator. Optionally, the generative model comprises a transformer model comprising a neural network encoder and a neural network decoder, the neural network encoder comprising an input layer, an output layer, one or more hidden layers, and a max pooling layer. Optionally, estimating the contribution of the first item of content, used to train the generative model, to the generative model output is based at least in part on labels associated with the first item of content, changes in weights of the generative model caused at least partly by training of the generative model using the first item of content, and/or based on an analysis of the output of the generative model. Optionally, the method further comprises estimating the contribution of the first item of content, used to train the generative model, to the generative model output using a neural network, a Support Vector Machine, a Random Forest, a probabilistic algorithm, and/or a K-Nearest Neighbors algorithm. Optionally, the feedback comprises label weights associated with labels assigned to the first item of content, an identification of a contribution to an adjustment of a weight of the generative model, and/or a token.

Optionally, estimating the contribution of the first item of content to the generative model output further comprises estimating a style contribution of the first item of content to the generative model output. Optionally, the method further comprises chunking text of at least a first document into a plurality of overlapping chunks; generating embeddings comprising vectors corresponding to the plurality of overlapping chunks; and storing the embeddings corresponding to the plurality of overlapping chunks in a vector database. Optionally, the method further comprises: generating a prompt instructing the generative model to use only specified document chunks in providing a response to the generated prompt; receiving a response to the generated prompt from the generative model; and determining similarities of the response to the generated prompt to the specified document chunks. Optionally, the method further comprises adjusting an attribution score for at least one content source based at least in part on user feedback with respect to generative model outputs generated using content from the at least one content source.

An aspect of the present disclosure relates to a computer-implemented method, the method comprising: receiving from a user device over a network at a computer system a user prompt for a generative model; analyzing, using the computer system, the user prompt and based at least on the analysis associating at least one prompt category with the user prompt, identifying at least one prompt keyword, and/or determining at least one user characteristic; using, by the computer system, the at least one prompt category with the user prompt, identifying at least one prompt keyword, and/or determining at least one user characteristics to identify a plurality of matching content providers; receiving at the computer system respective communications from two or more of the plurality of matching content providers; based at least in part on the received respective communications from the two or more of the plurality of matching content providers, selecting a first content provider of the two or more of the plurality of matching content providers; using content from the selected first content provider to train the generative model to generate a response to the user prompt and/or including content from the selected first content provider in generating a response to the user prompt; and causing the response to the user prompt to be transmitted to and displayed on the user device.

An aspect of the present disclosure relates to a computer-implemented method, the method comprising: receiving from a user device over a network at a computer system a user prompt for a generative model; accessing content from a plurality of websites associated with different sources; analyzing, using the computer system, the user prompt and the content from the plurality of websites associated with different sources; based at least in part on the analysis of the user prompt and the content from the plurality of websites, selecting a first content provider from the plurality of content providers; using content from the selected first content provider to train the generative model to generate a response to the user prompt and/or including content from the selected first content provider in generating a response to the user prompt; and causing the response to the user prompt to be transmitted to and displayed on the user device.

An aspect of the present disclosure relates to a system and computer-implemented method configured to perform operations comprising: installing a browser extension to a browser on a user device associated with a user, the user device comprising a display, memory, and a processing device; using the browser extension, identifying in a first user interface associated with a generative model: a user-provided generative model prompt; a prompt response provided by the generative model; and an identifier associated with the generative model; transmitting the user-provided generative model prompt, the prompt response provided by the generative model, and the identifier associated with the generative model, to a remote system; using, by the remote system, the user-provided generative model prompt, the prompt response provided by the generative model, and the identifier associated with the generative model, to determine a contribution of content from a first source to the model prompt response; and transmitting a notification to the first source regarding the contribution of content from the first source to the model prompt response.

Optionally, the operations further comprise anonymizing, by the browser extension, the user-provided generative model prompt, the prompt response provided by the generative model, and/or the identifier associated with the generative model, prior to the transmission to the remote system. Optionally, the operations further comprise identifying a user prompt field and a user prompt submit control in the user interface. Optionally, the operations further comprise identifying a user prompt field by at least accessing a DOM associated with the user interface and identifying elements that correspond to text fields or input fields. Optionally, the operations further comprise receiving an opt-in from the user to share selected information with the remote system. Optionally, the operations further comprise providing a first quantity of tokens to the user based at least in part on a quantity of user-provided generative model prompts and/or prompt responses provided by generative models provided via the browser extension.

An aspect of the present disclosure relates to a system and computer-implemented method configured to perform operations comprising: receiving a user-provided generative model prompt from a user device; determining a category associated with the user-provided generative model prompt; transmitting the category associated with the user-provided generative model prompt to a plurality of content sources; receiving requests from at least a first portion of the plurality of content sources to have their content used by a generative model in generating a response to the user-provided generative model prompt; selecting, from the requests, a first request from a first content source in the plurality of content sources using at least a first criterion; and causing the generative model to generate a response to the user-provided generative model prompt using content from the first content source, wherein the generate response is transmitted to and displayed by the user device.

Optionally, the first criterion relates to a token. Optionally, the first criterion relates to a quality score. Optionally, the operations further comprise transmitting user information to the plurality of content sources in association with the category. Optionally, the operations further comprise transmitting keywords to the plurality of content sources in association with the category. Optionally, the generative model prompt is anonymized.

An aspect of the present disclosure relates to a computer-implemented method, the method comprising: accessing an item of generated content from non-transitory memory: estimating a contribution of a first item of content to the generated content; generating feedback based at least in part on the estimated contribution of the first item of content to the generated content; and transmitting the feedback generated based at least in part on the estimated contribution of the first item of content to the generated content to one or more networked destinations.

Optionally, the method further comprises: estimating contribution percentages of a plurality of content items to the generated content; and transmitting corresponding pro rata feedback to respective sources of items in the plurality of content items. Optionally, the generated content is generated using a generative model. Optionally, the generated content comprises text, image data, or audio data. Optionally, the generated content comprises still and/or video image data. Optionally, the generated content is generated using a generative model, wherein the generative model comprises a transformer model comprising a neural network encoder and a neural network decoder, the neural network encoder comprising an input layer, an output layer, one or more hidden layers, and a max pooling layer. Optionally, the generated content is generated using a generative model, wherein estimating the contribution of the first item of content to the generated content is based at least in part on labels associated with the first item of content, changes in weights of a generative model used to generate the generated content caused at least partly by training of the generative model using the first item of content, and/or based on an analysis of the output of the generative model. Optionally, method further comprises estimating the contribution of the first item of content to the generated content using a neural network, a Support Vector Machine, a Random Forest, a probabilistic algorithm, and/or a K-Nearest Neighbors algorithm. Optionally, the feedback comprises label weights associated with labels assigned to the first item of content, an identification of a contribution to an adjustment of a weight of a generative model used to generate the generated content, and/or a token. Optionally, estimating the contribution of the first item of content to the generated content further comprises estimating a style contribution of the first item of content to the generated content. Optionally, the method further comprises: chunking text of at least a first document into a plurality of overlapping chunks; generating embeddings comprising vectors corresponding to the plurality of overlapping chunks; and storing the embeddings corresponding to the plurality of overlapping chunks in a vector database.

Optionally, the method further comprises: generating a prompt instructing a generative model to use only specified document chunks in providing a response to a prompt; receiving a response to the prompt from the generative model; and determining similarities of the response to the generated prompt to the specified document chunks. Optionally, the method further comprises adjusting an attribution score for at least one content source based at least in part on user feedback with respect to one or more items of generated content generated using content from the at least one content source. Optionally, the first item of content comprises text data, still image data, video image data, and/or audio data. Optionally, the estimated contribution of the first item of content to the generated model comprises an estimated contribution of vocabulary choice, sentence structure, grammar and punctuation, tone and voice, themes and topics, and/or rhetorical devices to the generated model. Optionally, the estimated contribution of the first item of content to the generated content comprises an estimated contribution of symbols, shapes, motifs, and/or iconography to the generated content. Optionally, the estimated contribution of the first item of content to the generated content comprises an estimated contribution to one or more claims of the generated content. Optionally, transmitting the feedback generated based at least in part on the estimated contribution of the first item of content to the generated content to one or more networked destinations, further comprises transmitting feedback to a plurality of networked destinations based at least in part on estimated percentage contributions of a plurality of items of content to the generated content. Optionally, the method further comprises transmitting an aggregated feedback for a first period of time to the one or more networked destinations.

An aspect of the present disclosure relates to computer system, the computer system comprising: a network interface; at least one processing device configured to: detect a prompt from a user device provided to a generative model; receive a response to the prompt provided by the generative model; extract a first set of one or more claims from the response provided by the generative model; receive an item of content associated with a corpus; extract a second set of one or more claims from the item of content; estimate a contribution of a first item of content to the response of generative model based on a similarity of the first set of one or more claims to the second set of one or more claims; generate feedback based at least in part on the estimated contribution of the first item of content to the response of the generative model; and transmit, using the network interface, the feedback generated based at least in part on the estimated contribution of the first item of content to the response of the generative model to one or more networked destinations.

Optionally, the item of content is one of a plurality of content items, and wherein the system is configured to: estimate a contribution of each of the plurality of content items to the response of the generative model; estimate contribution percentages of each of the plurality of content items to the response of the generative model; and transmit corresponding pro rata feedback to respective sources of the plurality of content items. Optionally, the generative model comprises a large language model. Optionally, the generative model comprises an image generator. Optionally, the generative model output comprises text, image data, or audio data. Optionally, the generative model output comprises still and/or video image data. Optionally, the first item of content comprises still image data, video image data, and/or audio data. Optionally, the first item of content comprises text data.

Optionally, the estimated contribution of the first item of content to the generative model output comprises an estimated contribution of style. Optionally, the estimated contribution of the first item of content to the generative model output comprises an estimated contribution of vocabulary choice, sentence structure, grammar and punctuation, tone and voice, themes and topics, and/or rhetorical devices to the generative model output. Optionally, the estimated contribution of the first item of content to the generative model output comprises an estimated contribution of symbols, shapes, motifs, and/or iconography to the generative model output. Optionally, the estimated contribution of the first item of content to the generative model output comprises an estimated contribution to one or more claims of the generative model output.

Optionally, transmitting the feedback generated based at least in part on the estimated contribution of the first item of content to the generative model output to one or more networked destinations, further comprises transmitting feedback to a plurality of networked destinations based at least in part on estimated percentage contributions of a plurality of items of content to the generative model output. Optionally, the system is configured to transmit an aggregated feedback for a first period of time to the one or more networked destinations. Optionally, the generative model comprises a transformer model comprising a neural network encoder and a neural network decoder, the neural network encoder comprising an input layer, an output layer, one or more hidden layers, and a max pooling layer. Optionally, the system is operable to estimate the contribution of the first item of content, used to train the generative model, to the generative model output based at least in part on labels associated with the first item of content, changes in weights of the generative model caused at least partly by training of the generative model using the first item of content, and/or based on an analysis of the output of the generative model. Optionally, the system is operable to estimate the contribution of the first item of content, used to train the generative model, to the generative model output using a neural network, a Support Vector Machine, a Random Forest, a probabilistic algorithm, and/or a K-Nearest Neighbors algorithm. Optionally, the feedback comprises label weights associated with labels assigned to the first item of content, an identification of a contribution to an adjustment of a weight of the generative model, and/or a token. Optionally, the feedback comprises label weights associated with labels assigned to the first item of content, an identification of a contribution to an adjustment of a weight of the generative model, and/or a token.

Optionally, estimating the contribution of the first item of content to the generative model output further comprises estimating a style contribution of the first item of content to the generative model output. Optionally, the computer system is operable to: chunk text of at least a first document into a plurality of overlapping chunks; generate embeddings comprising vectors corresponding to the plurality of overlapping chunks; and store the embeddings corresponding to the plurality of overlapping chunks in a vector database. Optionally, the computer system is operable to: generate a prompt instructing the generative model to use only specified document chunks in providing a response to the generated prompt; receive a response to the generated prompt from the generative model; and determine similarities of the response to the generated prompt to the specified document chunks. Optionally, the computer system is operable to adjust an attribution score for at least one content source based at least in part on user feedback with respect to generative model outputs generated using content from the at least one content source.

An aspect of the present disclosure relates to a computer-implemented method, the method comprising: accessing an item of generated content from non-transitory memory: estimating a contribution of a first item of content to the generated content based on a plurality of claims, wherein the plurality of claims comprise a first claim extracted from the generated content and a second claim extracted from the first item of content; generating feedback based at least in part on the estimated contribution of the first item of content to the generated content; and transmitting the feedback generated based at least in part on the estimated contribution of the first item of content to the generated content to one or more networked destinations.

Optionally, the method further comprises: estimating contribution percentages of a plurality of content items to the generated content; and transmitting corresponding pro rata feedback to respective sources of items in the plurality of content items. Optionally, the generated content is generated using a generative model. Optionally, the generated content comprises text, image data, or audio data. Optionally, the generated content comprises still and/or video image data. Optionally, the generated content is generated using a generative model, wherein the generative model comprises a transformer model comprising a neural network encoder and a neural network decoder, the neural network encoder comprising an input layer, an output layer, one or more hidden layers, and a max pooling layer.

Optionally, the generated content is generated using a generative model, wherein estimating the contribution of the first item of content to the generated content is based at least in part on labels associated with the first item of content, changes in weights of a generative model used to generate the generated content caused at least partly by training of the generative model using the first item of content, and/or based on an analysis of the output of the generative model. Optionally, the method further comprises estimating the contribution of the first item of content to the generated content using a neural network, a Support Vector Machine, a Random Forest, a probabilistic algorithm, and/or a K-Nearest Neighbors algorithm. Optionally, wherein the feedback comprises label weights associated with labels assigned to the first item of content, an identification of a contribution to an adjustment of a weight of a generative model used to generate the generated content, and/or a token.

Optionally estimating the contribution of the first item of content to the generated content further comprises estimating a style contribution of the first item of content to the generated content.

Optionally, the method further comprises: chunking text of at least a first document into a plurality of overlapping chunks; generating embeddings comprising vectors corresponding to the plurality of overlapping chunks; and storing the embeddings corresponding to the plurality of overlapping chunks in a vector database. Optionally, the method further comprises: generating a prompt instructing a generative model to use only specified document chunks in providing a response to a prompt; receiving a response to the prompt from the generative model; and determining similarities of the response to the generated prompt to the specified document chunks. Optionally, the method further comprises adjusting an attribution score for at least one content source based at least in part on user feedback with respect to one or more items of generated content generated using content from the at least one content source. Optionally, the first item of content comprises text data, still image data, video image data, and/or audio data. Optionally, the estimated contribution of the first item of content to the generated content comprises an estimated contribution of vocabulary choice, sentence structure, grammar and punctuation, tone and voice, themes and topics, and/or rhetorical devices to the generated model.

Optionally, the estimated contribution of the first item of content to the generated content comprises an estimated contribution of symbols, shapes, motifs, and/or iconography to the generated content. Optionally, the estimated contribution of the first item of content to the generated content comprises an estimated contribution to one or more claims of the generated content. Optionally, transmitting the feedback generated based at least in part on the estimated contribution of the first item of content to the generated content to one or more networked destinations, further comprises transmitting feedback to a plurality of networked destinations based at least in part on estimated percentage contributions of a plurality of items of content to the generated content. Optionally, the method further comprises transmitting an aggregated feedback for a first period of time to the one or more networked destinations.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources, or may comprise a standalone system. Two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone or mobile application, computer application, a short messaging service message (e.g., SMS, MMS, etc.), instant messaging, email, push notification, audibly, via haptic feedback, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, microphone, camera, touch pad, etc.), network interfaces, etc.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. § 112(f) will begin with the words “means for,” but use of the term “for” in any other context is not intended to invoke treatment under 35 U.S.C. § 112 (f). Accordingly, the applicant reserves the right to pursue additional claims after filing this application, in either this application or in a continuing application.

What is claimed is:

1. A computer system, the computer system comprising:
a network interface;
at least one processing device configured to:
detect a prompt from a user device provided to a generative model;
receive a response to the prompt provided by the generative model;
extract a first set of one or more claims from the response provided by the generative model;
receive an item of content associated with a corpus;
extract a second set of one or more claims from the item of content;
estimate a contribution of a first item of content to the response of generative model based on a similarity of the first set of one or more claims to the second set of one or more claims;
generate feedback based at least in part on the estimated contribution of the first item of content to the response of the generative model; and
transmit, using the network interface, the feedback generated based at least in part on the estimated contribution of the first item of content to the response of the generative model to one or more networked destinations.

2. The computer system as defined in claim 1, wherein the item of content is one of a plurality of content items, and wherein the system is configured to:
estimate a contribution of each of the plurality of content items to the response of the generative model;
estimate contribution percentages of each of the plurality of content items to the response of the generative model; and
transmit corresponding pro rata feedback to respective sources of the plurality of content items.

3. The computer system as defined in claim 1, wherein the generative model comprises a large language model.

4. The computer system as defined in claim 1, wherein the generative model comprises an image generator.

5. The computer system as defined in claim 1, wherein the generative model output comprises text, image data, or audio data.

6. The computer system as defined in claim 1, wherein the first item of content comprises still image data, video image data, and/or audio data.

7. The computer system as defined in claim 1, wherein the first item of content comprises text data.

8. The computer system as defined in claim 1, wherein the estimated contribution of the first item of content to the generative model output comprises an estimated contribution of style.

9. The computer system as defined in claim 1, wherein the estimated contribution of the first item of content to the generative model output comprises an estimated contribution of vocabulary choice, sentence structure, grammar and punctuation, tone and voice, themes and topics, and/or rhetorical devices to the generative model output.

10. The computer system as defined in claim 1, wherein the estimated contribution of the first item of content to the generative model output comprises an estimated contribution of symbols, shapes, motifs, and/or iconography to the generative model output.

11. The computer system as defined in claim 1, wherein the estimated contribution of the first item of content to the generative model output comprises an estimated contribution to one or more claims of the generative model output.

12. The computer system as defined in claim 1, wherein transmitting the feedback generated based at least in part on the estimated contribution of the first item of content to the generative model output to one or more networked destinations, further comprises transmitting feedback to a plurality of networked destinations based at least in part on estimated percentage contributions of a plurality of items of content to the generative model output.

13. The computer system as defined in claim 1, wherein the system is configured to transmit an aggregated feedback for a first period of time to the one or more networked destinations.

14. The computer system as defined in claim 1, wherein the system is operable to estimate the contribution of the first item of content, used to train the generative model, to the generative model output based at least in part on labels associated with the first item of content, changes in weights of the generative model caused at least partly by training of the generative model using the first item of content, and/or based on an analysis of the output of the generative model.

15. The computer system as defined in claim 1, wherein the system is operable to estimate the contribution of the first item of content, used to train the generative model, to the generative model output using a neural network, a Support Vector Machine, a Random Forest, a probabilistic algorithm, and/or a K-Nearest Neighbors algorithm.

16. The computer system as defined in claim 1, wherein the feedback comprises label weights associated with labels assigned to the first item of content, an identification of a contribution to an adjustment of a weight of the generative model, and/or a token.

17. The computer system as defined in claim 1, wherein the feedback comprises label weights associated with labels assigned to the first item of content, an identification of a contribution to an adjustment of a weight of the generative model, and/or a token.

18. The computer system as defined in claim 1, wherein estimating the contribution of the first item of content to the generative model output further comprises estimating a style contribution of the first item of content to the generative model output.

19. The computer system as defined in claim 1, wherein the computer system is operable to:
chunk text of at least a first document into a plurality of overlapping chunks;
generate embeddings comprising vectors corresponding to the plurality of overlapping chunks; and
store the embeddings corresponding to the plurality of overlapping chunks in a vector database.

20. The computer system as defined in claim 1, wherein the computer system is operable to:
generate a prompt instructing the generative model to use only specified document chunks in providing a response to the generated prompt;
receive a response to the generated prompt from the generative model; and
determine similarities of the response to the generated prompt to the specified document chunks.

21. The computer system as defined in claim 1, wherein the computer system is operable to adjust an attribution score for at least one content source based at least in part on user feedback with respect to generative model outputs generated using content from the at least one content source.

22. A computer-implemented method, the method comprising:
accessing an item of generated content from non-transitory memory:
estimating a contribution of a first item of content to the generated content based on a plurality of claims, wherein the plurality of claims comprise a first claim extracted from the generated content and a second claim extracted from the first item of content;
generating feedback based at least in part on the estimated contribution of the first item of content to the generated content; and
transmitting the feedback generated based at least in part on the estimated contribution of the first item of content to the generated content to one or more networked destinations.

23. The computer-implemented method as defined in claim 22, the method further comprising:
estimating contribution percentages of a plurality of content items to the generated content; and
transmitting corresponding pro rata feedback to respective sources of items in the plurality of content items.

24. The computer-implemented method as defined in claim 22, wherein the generated content comprises text, still image data, video image data, or audio data.

25. The computer-implemented method as defined in claim 22, wherein the generated content is generated using a generative model, wherein estimating the contribution of the first item of content to the generated content is based at least in part on labels associated with the first item of content, changes in weights of the generative model used to generate the generated content caused at least partly by training of the generative model using the first item of content, and/or based on an analysis of an output of the generative model.

26. The computer-implemented method as defined in claim 22, the method further comprising:
generating a prompt instructing a generative model to use only specified document chunks in providing a response to a prompt;
receiving a response to the prompt from the generative model; and
determining similarities of the response to the generated prompt to the specified document chunks.

27. The computer-implemented method as defined in claim 22, wherein the estimated contribution of the first item of content to the generated content comprises an estimated contribution of vocabulary choice, sentence structure, grammar and punctuation, tone and voice, themes and topics, and/or rhetorical devices to the generated content.

28. The computer-implemented method as defined in claim 22, wherein the estimated contribution of the first item of content to the generated content comprises an estimated contribution of symbols, shapes, motifs, and/or iconography to the generated content.

29. The computer-implemented method as defined in claim 22, wherein the estimated contribution of the first item of content to the generated content comprises an estimated contribution to one or more claims of the generated content.

30. The computer-implemented method as defined in claim 22, the method further comprising transmitting an aggregated feedback for a first period of time to the one or more networked destinations.
